(19) United States
(12) Patent Application Publication
(10) Pub. No.: US 2026/0311648 A1
(43) Pub. Date: Oct. 8, 2026

(54) DISPLAY PANEL AND DISPLAY DEVICE

(71) Applicant: Xiamen Tianma Display Technology Co., Ltd., Xiamen (CN)

(72) Inventors: Lijun LU, Xiamen (CN); Qingjun LAI, Xiamen (CN); Hongbo ZHOU, Xiamen (CN); Xingyao ZHOU, Xiamen (CN)

(21) Appl. No.: 19/567,786

(22) Filed: Mar. 16, 2026

(30) Foreign Application Priority Data
Apr. 3, 2025 (CN) 202510418027.0

(51) Int. Cl. G09G 3/3266; G09G 3/32

(52) U.S. Cl. CPC G09G 3/3266; G09G 3/32; G09G 2300/0426; G09G 2310/0267; G09G 2310/0286

(57) ABSTRACT

A shift register in a gate driving circuit includes a stage transfer unit and a gating unit. A first control unit in the stage transfer unit is configured to control a signal of a first node and a signal of a second node, and a first output unit is configured to output a stage transfer signal. A stage transfer signal of an i-th stage shift register is used as an input signal of a j-th stage shift register. The gating unit is configured to output a gate driving signal at least according to the stage transfer signal and a frequency control signal. The display panel includes a first voltage signal line used to transmit a first voltage signal and a second voltage signal line used to transmit a third voltage signal. The level type of the first voltage signal and the third voltage signal is the same.

### CROSS-REFERENCE TO RELATED APPLICATION

The present application claims priority of Chinese Patent Application No. 202510418027.0, filed on Apr. 3, 2025, the entire content of which is hereby incorporated by reference.

### TECHNICAL FIELD

The present application relates to the field of display technology, in particular to a display panel and a display device.

### BACKGROUND

With the continuous development of science and technology, more and more display products, such as mobile phones, tablets, laptops and smart wearable devices, are widely used in people's daily life and work, bringing great convenience to people's daily life and work, and becoming an indispensable tool for people today.

In display products, a gate driving circuit is usually configured to scan the pixel circuits line by line. The gate driving signal output by the gate driving circuit is affected by many node signals. How to improve the accuracy of the gate driving signal output by the gate driving circuit has become one of the technical problems that need to be solved urgently at this stage.

### SUMMARY

In order to solve the above technical problems, the present disclosure provides a display panel and a display device, aiming to improve the accuracy of the gate driving signal output by the driving circuit, thereby improving the display accuracy of the display panel.

In one aspect, the disclosure provides a display panel, including a gate driving circuit, the gate driving circuit including N stages of shift registers cascaded to each other, N≥2 and N being an integer, a shift register including a stage transfer unit and a gating unit connected to the stage transfer unit, and the stage transfer unit including a first control unit and a first output unit, where the first control unit is configured to control a signal of a first node and a signal of a second node according to at least a first voltage signal, a second voltage signal, a first clock signal, and a second clock signal; the first output unit is configured to output a stage transfer signal according to at least the signal of the first node, the signal of the second node, a third voltage signal and a fourth voltage signal, where a stage transfer signal of an i-th stage shift register is used as an input signal of a j-th stage shift register, where 1≤i≤N, 1≤j≤N, i≠j, i and j are both integers; the gating unit is configured to output a gate driving signal according to at least the stage transfer signal and a frequency control signal; and the display panel includes voltage signal lines, and the voltage signal lines include a first voltage signal line and a second voltage signal line, the first voltage signal line is used to transmit the first voltage signal, and the second voltage signal line is used to transmit the third voltage signal, and the first voltage signal and the third voltage signal have a same level type.

In another aspect, the present disclosure provides a display device, including a display panel, and the display panel including a gate driving circuit, the gate driving circuit including N stages of shift registers cascaded to each other, N≥2 and N being an integer, a shift register including a stage transfer unit and a gating unit connected to the stage transfer unit, and the stage transfer unit including a first control unit and a first output unit, where the first control unit is configured to control a signal of a first node and a signal of a second node according to at least a first voltage signal, a second voltage signal, a first clock signal, and a second clock signal; the first output unit is configured to output a stage transfer signal according to at least the signal of the first node, the signal of the second node, a third voltage signal and a fourth voltage signal, where a stage transfer signal of an i-th stage shift register is used as an input signal of a j-th stage shift register, where 1≤i≤N, 1≤j≤N, i≠j, i and j are both integers; the gating unit is configured to output a gate driving signal according to at least the stage transfer signal and a frequency control signal; and the display panel includes voltage signal lines, and the voltage signal lines include a first voltage signal line and a second voltage signal line, the first voltage signal line is used to transmit the first voltage signal, and the second voltage signal line is used to transmit the third voltage signal, and the first voltage signal and the third voltage signal have a same level type.

It should be understood that the content described in this section is not intended to identify the key or important features of the embodiments of the present disclosure, nor are they intended to limit the scope of the present disclosure. Other aspects of the present disclosure may be understood by those skilled in the art in light of the description, the claims, and the drawings of the present disclosure.

### BRIEF DESCRIPTION OF THE DRAWINGS

In order to more clearly illustrate the technical solutions of the embodiments of the present disclosure, the drawings required for use in the embodiments will be briefly introduced below. Apparently, the drawings described below are merely some embodiments of the present disclosure. For persons having ordinary skills in the art, it should be apparent that the basic concepts of device structure, driving method and manufacturing method disclosed and suggested by the embodiments of the present disclosure may be expanded and extended to other structures and drawings, and should be within the scope of the claims of the present disclosure.

FIG. 1 is a planar structural diagram of a display panel in accordance with an embodiment of the present disclosure;

FIG. 2 is a planar structural diagram of another display panel in accordance with an embodiment of the present disclosure;

FIG. 3 is a schematic diagram showing a connection of a shift register in a gate driving circuit in accordance with an embodiment of the present disclosure;

FIG. 4 is a schematic structural diagram of a shift register in a gate driving circuit in accordance with an embodiment of the present disclosure;

FIG. 5 is a circuit diagram of a pixel driving circuit in accordance with an embodiment of the present disclosure;

FIG. 6 is a circuit diagram of another pixel driving circuit in accordance with an embodiment of the present disclosure;

FIG. 7 is a timing diagram of the pixel driving circuit in FIG. 5;

FIG. 8 is a schematic simulation diagram of a first voltage signal and a third voltage signal;

FIG. 9 is a circuit diagram of a first control unit and a first output unit in a shift register in accordance with an embodiment of the present disclosure;

FIG. 10 is a circuit diagram of a gating unit in a display panel in accordance with an embodiment of the present disclosure;

FIG. 11 is a driving timing diagram of the stage transfer unit in FIG. 9 and the gating unit in FIG. 10;

FIG. 12 is a schematic diagram showing a connection between shift registers and voltage signal lines;

FIG. 13 is a schematic diagram showing a connection between voltage signal lines and fan-out lines in a display panel in accordance with an embodiment of the present disclosure;

FIG. 14 is a schematic structural diagram of a display panel after being bent through a bending area in accordance with an embodiment of the present disclosure;

FIG. 15 is a schematic diagram of film layers of a display panel in accordance with an embodiment of the present disclosure;

FIG. 16 is a cross-sectional view taken along the line AA of FIG. 13;

FIG. 17 is a schematic diagram showing film layers in which a first voltage signal line and a second voltage signal line are connected via a first connecting portion;

FIG. 18 is a schematic diagram of film layers of the first fan-out line and the second fan-out line in FIG. 13;

FIG. 19 is a BB cross-sectional view of FIG. 13;

FIG. 20 is another BB cross-sectional view of FIG. 13;

FIG. 21 is a schematic diagram showing another connection between voltage signal lines and fan-out lines in a display panel in accordance with an embodiment of the present disclosure;

FIG. 22 is a CC cross-sectional view of FIG. 21;

FIG. 23 is a schematic diagram showing a layout of some signal lines in the fan-out area and the bending area; and

FIG. 24 is a schematic structural diagram of a display device in accordance with an embodiment of the present disclosure.

### DETAILED DESCRIPTION

In order to more clearly understand the objectives, features and advantages of the present disclosure, the scheme of the present disclosure will be further described below. It should be noted that the embodiments of the present disclosure and the features in the embodiments may be combined with each other without conflict.

In the following descriptions, many specific details are set forth to facilitate a thorough understanding of the present disclosure, but the present disclosure may also be implemented in other ways different from those described herein. It is obvious that the embodiments in the specification are merely part of the embodiments of the present disclosure, rather than all of the embodiments.

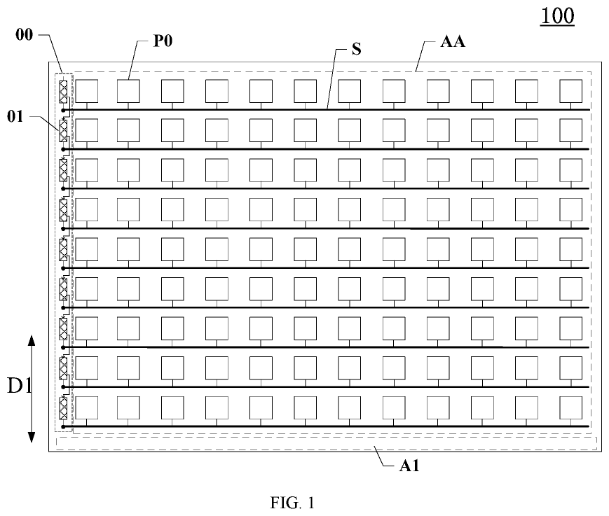

FIG. 1 is a planar structural diagram of a display panel 100 in accordance with an embodiment of the present disclosure. It should be noted that FIG. 1 merely uses a rectangular display panel as an example for illustration, and does not limit the actual shape of the display panel. In some embodiments, the display panel may also be embodied in any other feasible shape such as a circle or a rounded rectangle. Optionally, the display panel provided in the disclosed embodiments may be an organic light-emitting display panel, and the corresponding light-emitting elements are organic light-emitting elements. Apparently, in some embodiments, the display panel may also be a display panel using inorganic light-emitting diode display technology, such as a micro LED display panel, or a mini LED display panel, etc., which is not limited in the present disclosure.

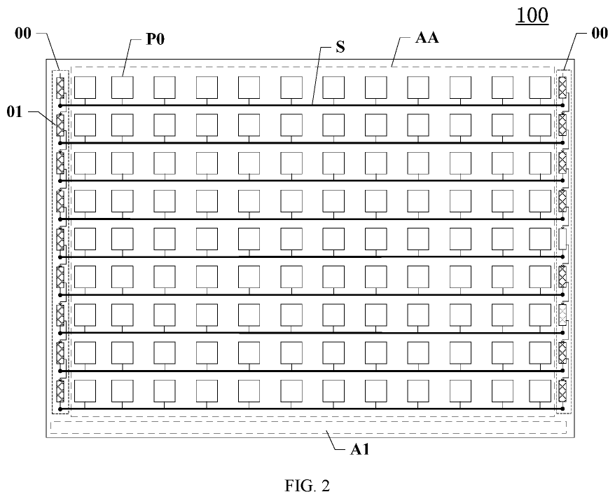

Optionally, the display panel 100 includes a plurality of pixel driving circuits P0, and FIG. 1 merely illustrates the pixel driving circuits in a rectangular structure, and does not limit the number and arrangement of the pixel driving circuits. In addition, the position of a gate driving circuit 00 in the display panel in FIG. 1 is merely for illustration, and is merely described by introducing a gate driving circuit group 00 in the display panel and setting the gate driving circuit 00 in the non-display area on one side of the display area AA as an example, but the present disclosure is not limited thereto. In some embodiments, two or more gate driving circuit groups 00 may be set in the display panel. When two gate driving circuit groups 00 are set in the display panel, the gate driving circuits 00 may be respectively set on two opposite sides of the display area AA. For example, refer to FIG. 2, which shows a planar structural diagram of another display panel in accordance with an embodiment of the present disclosure. A gate driving circuit 00 in the embodiments of the present disclosure is configured to provide a gate driving signal to the pixel driving circuits. The method of driving the pixel driving circuits by two gate driving circuit groups 00 is conducive to improving the transmission efficiency and transmission reliability of the gate driving circuits 00. It should be noted that, in some embodiments, the gate driving circuits 00 may also be disposed in the display area to achieve an extremely narrow frame or a frameless design of the display panel, and the specific position of the gate driving circuits of the present disclosure is not limited.

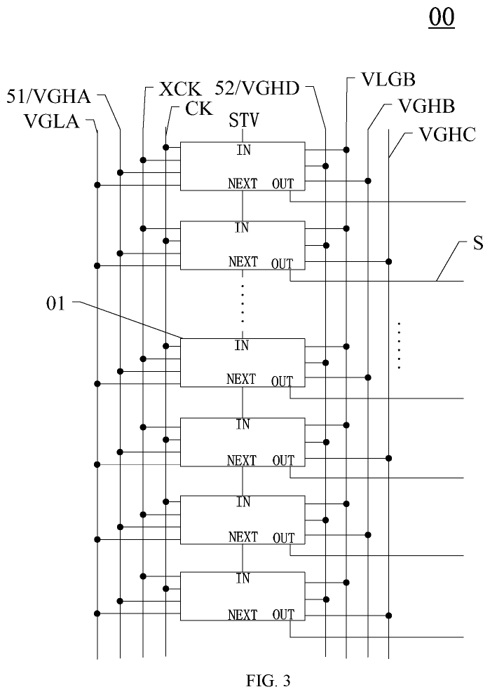

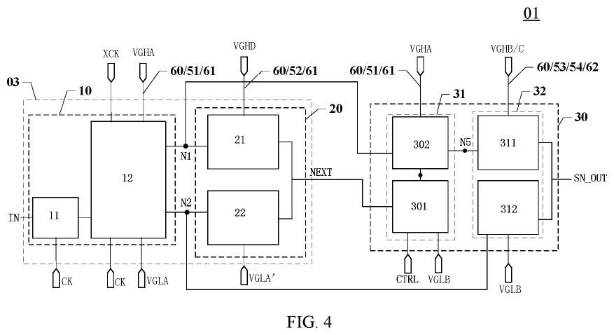

FIG. 3 is a schematic diagram showing a connection of a shift register 01 in a gate driving circuit 00 in accordance with an embodiment of the present disclosure, and FIG. 4 is a structural diagram of a shift register 01 in a gate driving circuit 00 in accordance with an embodiment of the present disclosure. Referring to FIG. 1 to FIG. 4, a display panel 100 in accordance with an embodiment of the present disclosure includes the following units.

A gate driving circuit 00 includes N stages of shift registers 01 cascaded with each other, where N≥2 and N is an integer. A shift register 01 includes a stage transfer unit 03 and a gating unit 30 connected to the stage transfer unit 03, and the stage transfer unit 03 includes a first control unit 10 and a first output unit 20. The first control unit 10 is configured to control the signal of a first node N1 and the signal of a second node N2 at least according to a first voltage signal VGHA, a second voltage signal VGLA, a first clock signal CK and a second clock signal XCK. The first output unit 20 is configured to output a stage transfer signal NEXT at least according to the signal of the first node N1, the signal of the second node N2, a third voltage signal VGHD and a fourth voltage signal VLGA′. The stage transfer signal NEXT of an i-th stage shift register 01 is used as an input signal of a j-th stage shift register 01, where 1≤i≤N, 1≤j≤N, i≠j, i and j are both integers. The gating unit 30 is configured to output a gate driving signal SN_OUT at least according to the stage transfer signal NEXT and a frequency control signal CTRL.

The display panel 100 includes a number of voltage signal lines 60, and the voltage signal lines 60 include a first voltage signal line 51 and a second voltage signal line 52. The first voltage signal line 51 is used to transmit the first voltage signal VGHA, and the second voltage signal line 52 is used to transmit the third voltage signal VGHD. The first voltage signal VGHA and the third voltage signal VGHD have a same level type. It should be noted that the same level type of the two voltage signals mentioned in the embodiments of the present disclosure means that both signals are high-level signals or low-level signals, but does not limit whether the voltage values of the two signals are the same.

The first control unit 10 is also electrically connected to an input signal terminal IN. The first control unit 10 is configured to receive the input signal IN, the first voltage signal VGHA, the second voltage signal VGLA, the first clock signal CK and the second clock signal XCK to control the signals of the first node N1 and the second node N2. For example, when the signal of the first node N1 is controlled to be at a valid level, the signal of the second node N2 may be controlled to be at an invalid level. Alternatively, when the signal of the second node N2 is controlled to be at a valid level, the signal of the first node N1 may be controlled to be at an invalid level. The first voltage signal VGHA and the second voltage signal VGLA are two signals of different level types. One of the first voltage signal VGHA and the second voltage signal VGLA may be a high-level signal, and the other may be a low-level signal.

The first output unit 20 is connected to at least the first node N1 and the second node N2, and receives the third voltage signal VGHD and the fourth voltage signal VGLA′ to control the stage transfer signal NEXT. For example, when the signal of the first node N1 is at a valid level, the third voltage signal VGHD will be output as the shift signal NEXT. That is, the shift signal NEXT is consistent with the third voltage signal VGHD. When the signal of the second node N2 is at a valid level, the fourth voltage signal VGLA′ will be output as the shift signal. That is, the shift signal NEXT is consistent with the fourth voltage signal VGLA′. Here, the third voltage signal VGHD and the fourth voltage signal VGLA′ are two signals of different level types. That is, one of the third voltage signal VGHD and the fourth voltage signal VGLA′ may be a high-level signal, and the other may be a low-level signal, so that one of the third voltage signal VGHD and the fourth voltage signal VGLA′ may be used as the valid level of the stage transfer signal, and the other may be used as the invalid level of the stage transfer signal.

The gating unit 30 receives at least the stage transfer signal NEXT, the frequency control signal CTRL, the signal of the first node N1 and the signal of the second node N2, so as to control the gate driving signal SN_OUT according to the stage transfer signal NEXT, the frequency control signal CTRL, the signal of the first node N1 and the signal of the second node N2. For example, when the signal of the second node N2 is a valid-level signal, the gate driving signal SN_OUT output by the gating unit 30 may be controlled to be consistent with a sixth voltage signal VGLB, and when the signal of a fifth node N5 is a valid-level signal, the gate driving signal SN_OUT output by the gating unit 30 may be controlled to be consistent with a fifth voltage signal VGHB or a seventh voltage signal VGHC. The working timing of the stage transfer unit 03 and the gating unit 30 will be described in the subsequent embodiments.

Referring continuously to FIGS. 1 and 2, in the display panel provided by the embodiments of the present disclosure, the output terminal of a shift register 01 is connected to a scan line S, and the scan line S is further electrically connected to the pixel driving circuits P0. The shift register 01 provides a gate driving signal to the pixel driving circuits P0 through the scan line S. The gate driving signal includes, for example, a reset control signal, a data writing control signal, a light-emitting control signal, etc., to control the operation of the pixel driving circuits. Optionally, at least two different control signals correspond to different gate driving circuits. For example, a gate driving circuit that sends a reset control signal and a gate driving circuit that sends a light-emitting control signal are two independent gate driving circuits.

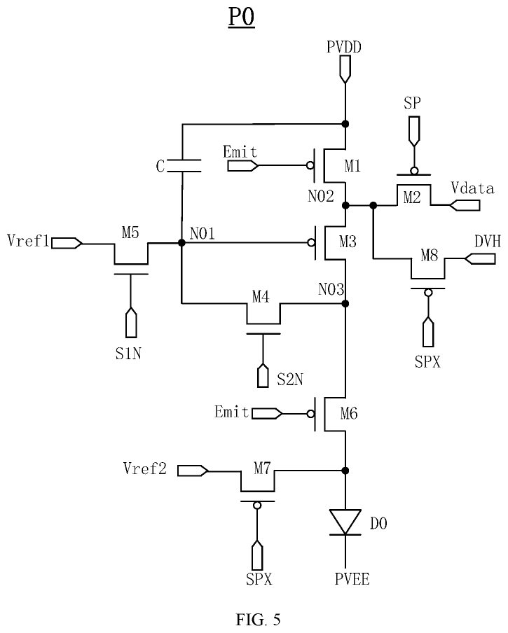

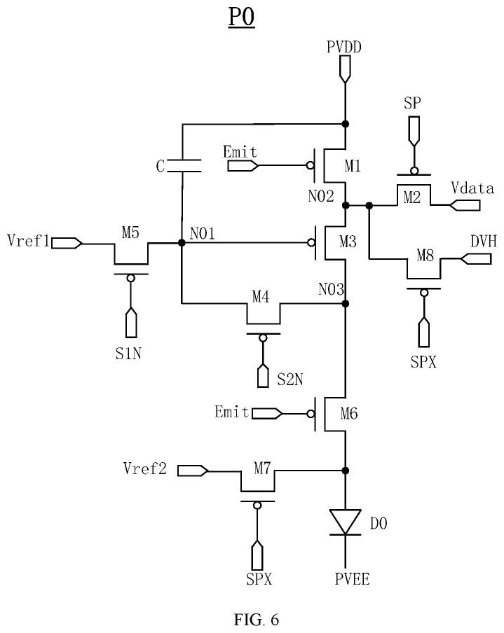

FIG. 5 is a circuit diagram of a pixel driving circuit in accordance with an embodiment of the present disclosure. Taking FIG. 5 as an example, the pixel driving circuit P0 includes a first transistor M1, a second transistor M2, a third transistor M3, a fourth transistor M4, a fifth transistor M5, a sixth transistor M6, a seventh transistor M7, an eighth transistor M8 and a capacitor C. The third transistor M3 is a driving transistor, which is configured to provide a driving current for a light-emitting element D0. The gate, the first electrode and the second electrode of the driving transistor are respectively connected to a first subnode N01, a third subnode N03 and a second subnode N02. The first electrode and the second electrode of the fifth transistor M5 are respectively connected to a first reset signal terminal Vref1 and the first subnode N01, the gate is connected to a first control signal terminal S1N, and is configured to receive a reset control signal. The fifth transistor M5 is configured to provide a first reset signal Vref1 to the first subnode N01. The first electrode and the second electrode of the second transistor M2 are respectively connected to a data voltage signal terminal Vdata and the second subnode N02, the gate receives a control signal SP, and the second transistor M2 is configured to transmit a data voltage signal Vdata to the second subnode N02. It should be noted that a signal terminal and the signal transmitted by the signal terminal in the embodiments of the present disclosure are represented by a same reference numeral. The first electrode and the second electrode of the fourth transistor M4 are respectively connected to the third subnode N03 and the first subnode N01, and the gate is connected to a second control signal terminal S2N for receiving a control signal S2N. The fourth transistor M4 is configured to perform threshold compensation on the third transistor M3. The first electrode and the second electrode of the seventh transistor M7 are respectively connected to a second reset signal terminal Vref2 and a first electrode of the light-emitting element D0, and the gate is connected to a control signal terminal SPX. The seventh transistor M7 is configured to reset the first electrode of the light-emitting element D0. The first electrode and the second electrode of the eighth transistor M8 are respectively connected to a bias adjustment signal terminal DVH and the second subnode N02, and the gate is connected to the control signal terminal SPX. The first electrode and the second electrode of the first transistor M1 are respectively connected to a first power signal terminal PVDD and the second subnode N02, and the gate is connected to a light control signal terminal Emit. The first electrode and the second electrode of the sixth transistor M6 are respectively connected to the third subnode N03 and the first electrode of the light-emitting element D0, and the gate is connected to the light control signal terminal Emit, which is configured to transmit a driving current to the light-emitting element D0. The second electrode of the light-emitting element D0 receives a second power supply signal PVEE. It should be noted that the embodiments of the present disclosure are merely described by taking the gates of the seventh transistor M7 and the eighth transistor M8 as connected to the control signal terminal SPX, but the present disclosure is not limited thereto. It should also be noted that the pixel driving circuit in FIG. 5 is merely for illustration, and the present disclosure does not limit the specific structure of a pixel driving circuit. In the embodiment of FIG. 5, the fourth transistor M4 and the fifth transistor M5 connected to the first sub-node N01 are N-type transistors, and the N-type transistors may be oxide transistors. The signal for controlling the conduction of the fourth transistor M4 and the fifth transistor M5 is a high-level signal. The other transistors are all P-type transistors. In the disclosed embodiment, the fourth transistor M4 and the fifth transistor M5 are N-type transistors. When the N-type transistors are oxide transistors, it helps reduce the leakage of the fourth transistor M4 and the fifth transistor M5 to the first sub-node N01, thereby facilitating the stability of the potential of the gate of the driving transistor connected to the first sub-node N01. In some embodiments, the pixel driving circuit may also be other structures. For example, refer to FIG. 6, which is a circuit schematic diagram of another pixel driving circuit in accordance with an embodiment of the present disclosure. The connection relationship and working principle are similar to those in FIG. 5, and the difference from FIG. 5 is that the fourth transistor M4 and the fifth transistor M5 are P-type transistors, and the P-type transistors are turned on under the control of a low-level signal. When all the transistors in the embodiment shown in FIG. 6 are P-type transistors, it helps simplify the manufacturing process of the pixel driving circuit.

In the pixel driving circuits shown in FIG. 5 and FIG. 6, the first control signal terminal S1N, the second control signal terminal S2N, the light-emitting control signal terminal Emit, and the control signal terminals SP and SPX are all connected to the gate driving circuits. Optionally, the first control signal terminal S1N and the second control signal terminal S2N may correspond to a same group of gate driving circuits, and the light-emitting control signal terminal Emit, the control signal terminals SP and SPX may correspond to other different gate driving circuits. Apparently, in some embodiments, the first control signal terminal S1N and the second control signal terminal S2N may also correspond to different gate driving circuits. It should be noted that in the disclosed embodiment, merely the structure corresponding to the gate driving circuits when the first control signal S1N and the second control signal S2N correspond to the same group of gate driving circuits is described, and the structure of other gate driving circuits in the display panel is not limited.

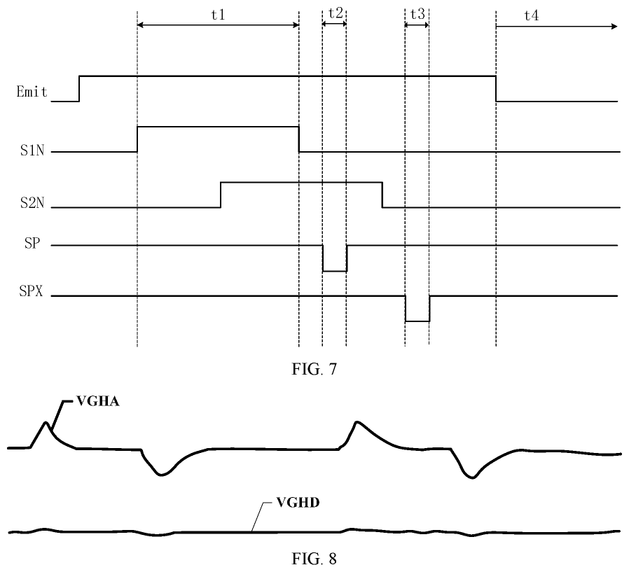

The working principle of the pixel driving circuit in FIG. 5 will be described below in conjunction with FIG. 7, and the working principle of the pixel driving circuit in FIG. 6 may refer to this embodiment. FIG. 7 shows a timing diagram of the pixel driving circuit in FIG. 5. In conjunction with FIG. 5 and FIG. 7, the specific working process of the pixel driving circuit P0 includes an initialization phase t1, a data writing and threshold compensation phase t2, a bias phase t3, and a light-emitting phase t4.

In the initialization phase t1, the high-level signal of the first control signal S1N controls the fifth transistor M5 to be turned on, and transmits the first reset signal Vref1 to the control terminal of the third transistor M3 for initialization, so as to eliminate the residual charge of a previous frame to improve the display effect of the display panel. In the present disclosure, in a part of the time period of the initialization phase t1, the valid levels of the first control signal S1N and the second control signal S2N have an overlap time, which is conducive to improving the hysteresis problem of the driving transistor during the initialization phase.

In the data writing and threshold compensation phase t2, the fifth transistor M5 is turned off, the control signal SP controls the second transistor M2 to be turned on, the second control signal S2N controls the fourth transistor M4 to be turned on, and the data voltage signal Vdata is written into the third transistor M3 through the second transistor M2. The fourth transistor M4 is connected between the gate and the first electrode of the third transistor M3, and the threshold voltage of the third transistor M3 may be captured onto the gate of the third transistor M3, thereby realizing the compensation of the threshold voltage and self-compensating the deviation of the threshold voltage of the driving transistor.

In the bias phase t3, the control signal SPX controls the eighth transistor M8 to be turned on, and the bias adjustment signal DVH is transmitted to the second electrode (i.e., the second subnode N02) of the driving transistor through the eighth transistor M8 to adjust the bias state of the driving transistor. At the same time, the control signal SPX controls the seventh transistor M7 to be turned on, and the second reset signal Vref2 is transmitted to the anode of the light-emitting element D0 through the seventh transistor M7 to reset the light-emitting element D0.

In the light-emitting phase t4, the second transistor M2, the fourth transistor M4, the fifth transistor M5 and the seventh transistor M7 are all turned off, the first transistor M1, the third transistor M3 and the sixth transistor M6 are all turned on, the driving current is transmitted to the first electrode of the light-emitting element D0, and the light-emitting element D0 emits light. It should be noted that the timing diagram of FIG. 7 is merely for illustration and is not for limitation. In some embodiments, pixel driving circuits with different structures may correspond to different timing diagrams.

Optionally, the first control signal S1N and the second control signal S2N received by the above pixel driving circuit are provided by two different groups of gate driving circuits. In some embodiments, a gate driving signal SN_OUT output by a gate driving circuit 00 may be used as the first control signal S1N provided to the pixel driving circuits, and the second control signal S2N is provided by other gate driving circuits. At this moment, a gate driving circuit is configured to provide the first control signal S1N to the fifth transistor M5 at least in the initialization phase t1, so that the fifth transistor M5 is turned on, and the first reset signal Vref1 is transmitted to the third transistor M3, so that the potential of the first sub-node N01 becomes low.

When the display panel needs to implement partition refresh, in two adjacent display areas, the pixel driving circuits in one display area need to be refreshed (i.e., the first control signal terminals S1N need to receive a valid-level signal in the gate driving signal), while the pixel driving circuits in the other display area do not need to be refreshed (i.e., the first control signal terminals S1N need to receive an invalid-level signal in the gate driving signal). Therefore, the accuracy of the gate driving signal output by a gate driving circuit 00 in the embodiments of the present disclosure directly determines whether the pixel driving circuits may control the corresponding light-emitting elements to emit light correctly.

In some embodiments, the gate driving signal SN_OUT output by a gate drive circuit 00 may be used as the second control signal S2N provided to the pixel drive circuits, and the first control signal S1N is provided by other gate drive circuits. At this moment, the gate drive circuit is configured to provide the second control signal S2N to the fourth transistor in the data writing and threshold compensation phase t2 to achieve threshold voltage compensation.

Apparently, in some embodiments, a gate driving circuit that transmits the first control signal S1N and a gate that transmits the second control signal S2N to the pixel driving circuits may also be the same gate driving circuit. That is, the gate driving circuit provided in the embodiments of the present disclosure may realize the transmission of the first control signal S1N and the second control signal S2N to the pixel driving circuits. For example, in a gate driving circuit provided by the present disclosure, the output of a shift register at a current stage may provide a first control signal S1N and a second control signal S2N to the pixel driving circuits of different rows respectively. For this, reference may be made to the contents of the relevant technology, and the present disclosure does not make any specific limitations on this.

Referring continuously to FIG. 4, for the first control unit 10 in the shift register 01, it controls the signals of the first node N1 and the second node N2 according to the input signal IN, the first clock signal CK, the second clock signal XCK, the first voltage signal VGHA and the second voltage signal VGLA. For the first output unit 20, it controls the output of the stage transfer signal NEXT according to the third voltage signal VGHD, the fourth voltage signal VGLA′ and the signals of the first node N1 and the second node N2. In the existing technologies, in the first control unit 10, due to the circuit logic itself, the first clock signal CK or the second clock signal XCK will cause coupling interference to the first voltage signal VGHA, so that the first voltage signal VGHA, which is originally constant in voltage, will have sawtooth transitions between high and low levels. For example, refer to FIG. 8, which is a simulation schematic diagram of the first voltage signal VGHA and the third voltage signal VGHD. The first voltage signal VGHA will have sawtooth due to the coupling influence of the clock signal. In the present disclosure, when the first output unit 20 separately introduces a second voltage signal line 52 to transmit the third voltage signal VGHD, the third voltage signal VGHD is not or is hardly affected by the coupling influence of the clock signal. If the third voltage signal VGHD in the first output unit 20 and the first voltage signal VGHA in the first control unit 10 are the same signal transmitted by a same signal line, the third voltage signal VGHD will also be affected by the clock signal and produce a sawtooth of high-low level leaps. When the third voltage signal VGHD is output as a stage transfer signal, the stage transfer signal will also produce a sawtooth of high-low level leaps, thereby affecting the control of the gating unit 30, causing the gating unit 30 to output errors, affecting the control of the pixel driving circuits.

In order to solve the above problems, the first voltage signal VGHA corresponding to the first control unit 10 in the embodiments of the present disclosure is transmitted by a first voltage signal line 51, and the third voltage signal VGHD corresponding to the first output unit 20 is transmitted by a second voltage signal line 52. The level type of the first voltage signal VGHA and the third voltage signal VGHD is the same. That is, both are high-level signals or both are low-level signals, but the two are transmitted by different voltage signal lines. When the coupling of the clock signal affects the first voltage signal VGHA, since the third voltage signal VGHD is transmitted by the second voltage signal line 52, the third voltage signal VGHD is not affected by the coupling of the clock signal. When the stage transfer signal NEXT output by the first output unit 20 is the third voltage signal VGHD, the third voltage signal VGHD is a stable voltage signal transmitted by the second voltage signal line 52, which may realize accurate control of the gating unit 30. Therefore, the embodiments of the present disclosure introduce different voltage signal lines into the first control unit 10 and the first output unit 20 to transmit the first voltage signal VGHA and the third voltage signal VGHD of the same level type, which helps improve the transmission accuracy of the stage transfer signal NEXT, and further improve the accuracy of the gate driving signal output by the gate drive circuit 00.

In some embodiments, the third voltage signal VGHD corresponds to a valid-level signal in the stage transfer signal. In other words, the third voltage signal VGHD is output as a valid-level signal in the stage transfer signal. Because the valid level of the stage transfer signal is a signal related to the valid level of the gate driving signal, and the valid level of the gate driving signal directly affects the conduction state of the corresponding transistor, the use of a single second voltage signal line 52 to transmit the third voltage signal VGHD may ensure the stability of the output of the third voltage signal VGHD. In addition, the stage transfer signal of the current stage shift register will be transmitted to a next stage shift register as the input signal of the next stage shift register, so the use of a single second voltage signal line 52 to transmit the third voltage signal VGHD may also ensure the stability of the valid level of the input signal of the next stage shift register, so that the valid level of the input signal of the next stage shift register remains constant and is free from interference from other signals.

The working principle and related technical effects of the gate driving circuit 00 in the embodiments of the present disclosure will be further described below in combination with a specific circuit structure.

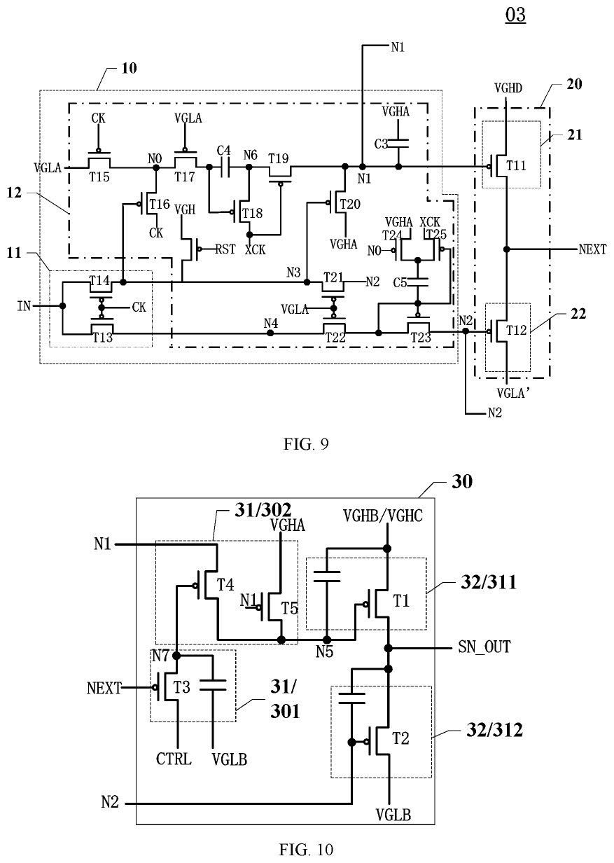

FIG. 9 is a circuit diagram of the first control unit 10 and the first output unit 20 in the shift register 01 in accordance with an embodiment of the present disclosure. By way of example, the first control unit 10 includes a first control module 11 and a second control module 12. The first control module 11 is configured to receive an input signal IN, and to control the signals of the third node N3 and the fourth node N4 in response to the first clock signal CK, where the signal of the third node N3 is connected to the second node N2. The second control module 12 is configured to receive a first voltage signal VGHA and a second voltage signal VGLA, and to control the signals of the first node N1 and the second node N2 in response to the signal of the third node N3, the signal of the fourth node N4, the first clock signal CK and the second clock signal XCK, where the voltage signal VGHA is provided by the first voltage signal line.

Exemplarily, the first control module 11 includes a transistor T13 and a transistor T14, the first electrode of the transistor T13 is connected to the input signal terminal IN, the second electrode is connected to the fourth node N4, and the gate is connected to the first clock signal CK. The first electrode of the transistor T14 is connected to the input signal terminal IN, the second electrode is connected to the third node N3, and the gate receives the first clock signal CK.

Exemplarily, the second control module 12 includes transistors T15 to T25, and capacitors C3, C4 and C5. The first electrode of transistor T15 receives the second voltage signal VGLA, the gate receives the first clock signal CK, and the second electrode is connected to node N0. The gate of transistor T16 is connected to the third node N3, the first electrode receives the first clock signal CK, and the second electrode is connected to node N0. The first electrode of transistor T17 is connected to node N0, the gate receives the second voltage signal VGLA, the second electrode is connected to the first plate of capacitor C4, and the second plate of capacitor C4 is connected to node N6. The first electrode of transistor T18 receives the second clock signal XCK, the gate is connected to the first plate of capacitor C4, and the second electrode is connected to node N6. The first electrode of transistor T19 is connected to node N6, the second electrode of transistor T19 is connected to the first node N1, and the gate receives the second clock signal XCK. The first electrode of transistor T20 receives the first voltage signal VGHA, the second electrode is connected to the first node N1, and the gate is connected to the third node N3. The two plates of capacitor C3 receive the first voltage signal VGHA and the signal of the first node N1 respectively. The first electrode of the transistor T21 is connected to the third node N3, the second electrode is connected to the second node N2, and the gate receives the second voltage signal VGLA. The first electrode of the transistor T22 is connected to the fourth node N4, the second electrode is connected to the first electrode of the transistor T23, and the gate receives the second voltage signal VGLA. The first electrode and the gate of the transistor T23 are connected to the second electrode of the transistor T22, and the second electrode of the transistor T23 is connected to the second node N2. The first electrode plate of the capacitor C5 is connected to the gate of the transistor T23, and the second electrode plate is connected to the second electrodes of the transistors T24 and T25. The first electrode of the transistor T24 receives the first voltage signal VGHA, and the gate is connected to the node N0. The first electrode of the transistor T25 receives the second clock signal XCK, and the gate is connected to the gate of the transistor T23.

Exemplarily, the first output unit 20 includes a first output module 21 and a second output module 22, the first output module 21 includes a transistor T11, and the second output module 22 includes a transistor T12. The gate of the transistor T11 is connected to the first node N1, the first electrode receives the third voltage signal VGHD, and the second electrode outputs the stage transfer signal NEXT. The gate of the transistor T12 is connected to the second node N2, the first electrode receives the fourth voltage signal VGLA′, and the second electrode outputs the stage transfer signal NEXT.

It should be noted that the circuit structure of the first control unit 10 and the first output unit 20 shown in FIG. 9 is merely for illustration, and the specific structures of the first control unit 10 and the first output unit 20 are not specifically limited. In some embodiments, the first control unit 10 and the first output unit 20 may also adopt other feasible circuit structures. The transistors in the first control unit 10 and the first output unit 20 are also merely for illustration. In some embodiments, the structure of at least some of the transistors may also be changed to a dual-gate structure.

FIG. 10 is a circuit diagram of the gating unit 30 in the display panel provided by the embodiments of the present disclosure. Optionally, the gating unit 30 includes a second control unit 31 and a second output unit 32. The second control unit 31 is configured to control the signal of the fifth node N5 at least according to the signal of the first node N1, the first voltage signal VGHA, the stage transfer signal NEXT and the frequency control signal CTRL. The second output unit 32 is configured to output a gate driving signal at least according to the signals of the fifth node N5 and the second node N2.

Referring to FIG. 4 and FIG. 10, illustratively, the second control unit 31 in a gating unit 30 includes an isolation protection unit 301 and an output control unit 302, and the second output unit 32 includes a third output module 311 and a fourth output module 312. The control terminal of the isolation protection unit 301 receives the stage transfer signal NEXT, the input terminal of the isolation protection unit 301 receives the frequency control signal CTRL, the output terminal of the isolation protection unit 301 is connected to the control terminal of the output control unit 302. The isolation protection unit 301 may control the signal output to the control terminal of the output control unit 302 according to the stage transfer signal NEXT and the frequency control signal CTRL. The output control unit 302 receives the signal of the first node N1 and the first voltage signal VGHA, and the output terminal is connected to the control terminal of the third output module 311 through the fifth node N5. For example, when the stage transfer signal NEXT may control the isolation protection unit 301 to be turned on, the isolation protection unit 301 may transmit the frequency control signal CTRL to the control terminal of the output control unit 302. When the stage transfer signal NEXT controls the isolation protection unit 301 to be turned off, the frequency control signal CTRL may be stopped from being output to the control terminal of the output control unit 302. The output control unit 302 may control the signal of the fifth node N5 according to at least the signal of the first node N1 and the first voltage signal VGHA.

Optionally, the isolation protection unit 301 includes a transistor T3, and the output control unit 302 includes transistors T4 and T5. The gate of the transistor T3 receives the stage transfer signal NEXT, the first electrode receives the frequency control signal CTRL, and the second electrode is connected to the gate of the transistor T4. The first electrode of the transistor T4 is connected to the first node N1, and the second electrode is connected to the fifth node N5. The gate of the transistor T5 is connected to the first node N1, the first electrode receives the first voltage signal VGHA, and the second electrode is connected to the fifth node N5. The third output module 311 includes a transistor T1, and the fourth output module 312 includes a transistor T2. The gate of the transistor T1 is connected to the fifth node N5, the first electrode receives a fifth voltage signal VGHB or a seventh voltage signal VGHC, and the second electrode is connected to the output terminal SN_OUT of the gating unit 30. The gate of the transistor T2 is connected to the second node N2, the first electrode receives a sixth voltage signal VGLB, and the second electrode is connected to the output terminal SN_OUT of the gating unit 30.

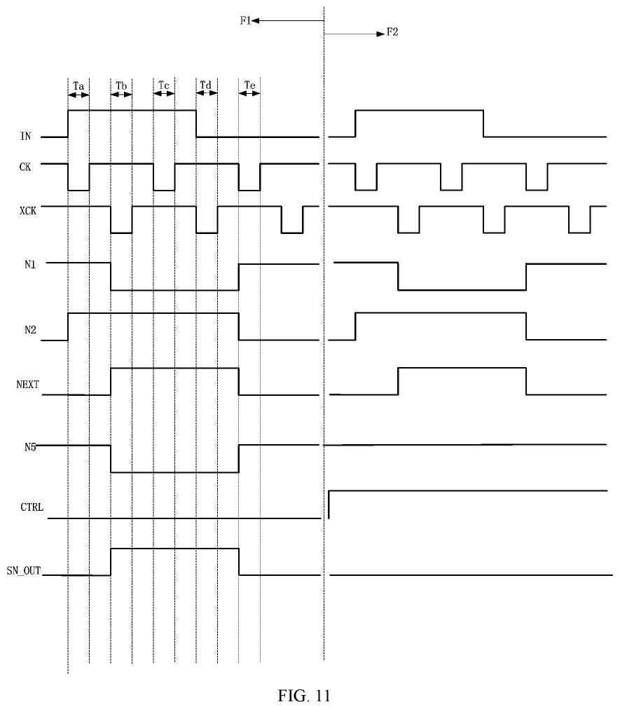

FIG. 11 is a driving timing diagram of the stage transfer unit 03 in FIG. 9 and the gating unit 30 in FIG. 10. The working principle and working process of the shift register will be described in combination with FIG. 9, FIG. 10 and FIG. 11.

In the Ta phase, the input signal IN is at a high level and the first clock signal CK is at a low level. At this moment, the transistors T13, T14 and T15 are turned on, and the input signal IN is transmitted to the third node N3 and the fourth node N4 respectively through the transistors T13 and T14, so that the third node N3 and the fourth node N4 are both at a high level, and the transistors T16 and T20 are turned off. At the same time, the second voltage signal VGLA is transmitted to the node N0 through the transistor T15, the node N0 is at a low level, and the transistor T17 is normally turned on, and the low level signal is transmitted to the gate of the transistor T18. The transistor T18 is turned on, the second clock signal XCK is at a high level, the transistor T19 is turned off, the first node N1 maintains the high level of the previous stage, the transistor T11 is turned off, and the stage transfer signal NEXT maintains the low level of the previous stage.

In the Tb phase, the input signal IN is at a high level, and the first clock signal CK is at a high level. At this moment, the transistors T13, T14 and T15 are turned off, the third node N3 and the fourth node N4 remain at a high level, the transistors T16 and T20 are turned off, and the node N0 remains at a low level. The transistor T18 is turned on, the second clock signal XCK is at a low level, and is transmitted to the sixth node N6 through the transistor T18, so that the sixth node N6 is at a low level. The transistor T19 is turned on, the signal of the sixth node N6 is transmitted to the first node N1, the transistor T11 is turned on, and the third voltage signal VGHD is transmitted to the output terminal, so that the stage transfer signal NEXT is at a high level.

In the Tc phase, the input signal IN is at a high level and the first clock signal CK is at a low level. At this moment, the transistors T13, T14 and T15 are turned on, and the input signal IN is transmitted to the third node N3 and the fourth node N4 respectively through the transistors T13 and T14, so that the third node N3 and the fourth node N4 are both at a high level, and the transistors T16 and T20 are turned off. At the same time, the second voltage signal VGLA is transmitted to the node N0 through the transistor T15, the node N0 is at a low level, and the transistor T17 is normally turned on, then the second electrode of the transistor T17 is at a low level. The transistor T18 is turned on, the second clock signal XCK is at a high level, the sixth node N6 remains at a high level, the transistor T19 is turned off, the first node N1 remains at a low level, the transistor T11 is turned on, and the third voltage signal VGHD is transmitted to the output terminal, so that the stage transfer signal NEXT is at a high level.

In the Td phase, the input signal IN is at a low level, the first clock signal CK is at a high level, the transistors T13, T14 and T15 are all turned off, the third node N3 and the fourth node N4 are both kept at a high level, and the transistors T16 and T20 are both turned off. The node N0 is kept at a low level, and the transistor T17 is normally turned on, the second electrode of the transistor T17 is at a low level, and the transistor T18 is turned on. The second clock signal XCK is at a low level, and the second clock signal XCK is transmitted to the sixth node N6 through the transistor T18, so that the sixth node N6 is at a low level. At the same time, the transistor T19 is turned on, the signal of the sixth node N6 is transmitted to the first node N1 at a low level, the transistor T11 is turned on, and the third voltage signal VGHD is transmitted to the output terminal, so that the stage transfer signal NEXT is at a high level.

In the Te phase, the input signal IN is at a low level, the first clock signal CK is at a low level, the transistors T13, T14 and T15 are turned on, the input signal IN is transmitted to the third node N3 and the fourth node N4 respectively through the transistors T13 and T14, so that the third node N3 and the fourth node N4 are both at a low level, and the transistors T16 and T20 are turned on. At the same time, the transistor T15 is turned on, the second voltage signal VGLA is transmitted to the node N0 through the transistor T15, the node N0 is at a low level, and the transistor T17 is normally turned on. The second electrode of transistor T17 is at a low level, transistor T18 is turned on, the second clock signal XCK is at a high level, the sixth node N6 maintains a high level, and transistor T19 is turned off. The transistor T20 is turned on, and the first voltage signal VGHA is transmitted to the first node N1 through transistor T20, so that the first node N1 is at a high level, and transistor T11 is turned off. At the same time, transistor T21 and transistor T22 are normally turned on, and the signal of the third node N3 is transmitted to the second node N2, so that the second node N2 is at a low level. The transistor T12 is turned on, and the fourth voltage signal VGLA′ is transmitted to the output terminal, so that the stage transfer signal NEXT is at a low level.

Optionally, in some embodiments, the fourth voltage signal VGLA′ received by the first output unit 20 and the second voltage signal VGLA received by the first control unit 10 are signals with the same voltage value, but the present disclosure is not limited thereto. In some embodiments, the two may also be signals with the same level type but different voltage values.

Referring to FIG. 4 and FIG. 9 to FIG. 11, in a same shift register, when the shift signal NEXT output by the first output unit 20 controls the transistor T3 to turn on, the frequency control signal CTRL will be transmitted to the seventh node N7. At this moment, if the frequency control signal NEXT is a valid-level signal, the signal of the seventh node N7 will also be a valid-level signal. If the frequency control signal NEXT is an invalid-level signal, the signal of the seventh node N7 will also be an invalid-level signal. When the signal of the seventh node N7 is a valid-level signal, the transistor T4 may be controlled to be turned on, and the signal of the first node N1 will be able to be transmitted to the fifth node N5, so that the signal of the fifth node N5 is consistent with the signal of the first node N1. At this moment, the shift signal NEXT output by the first output unit 20 may be controlled to be consistent with the gate driving signal output by the second output unit 32. That is, when the shift signal NEXT is a valid-level signal, the gate driving signal will also be a valid-level signal. When the signal at the seventh node N7 is an invalid-level signal, the transistor T4 cannot be turned on, and the signal of the first node N1 cannot be transmitted to the fifth node N5, so that the gate driving signal cannot be synchronized with the shift signal NEXT and remain as a valid-level signal.

In the disclosed embodiments, by making the frequency control signal CTRL include a valid-level signal and an invalid-level signal, in a part of the time period (for example, a frame picture display time F1), when the shift signal NEXT is controlled to be a valid-level signal, the frequency control signal CTRL maintains a valid level (the embodiments take a low level signal as an example of the valid-level signal of the frequency control signal CTRL), the seventh node N7 is a valid level, so that the shift register outputs the valid level of the gate driving signal in this time period. The pixel drive circuits electrically connected to the shift register may thus perform signal refresh. In another part of the time period (for example, a frame picture display time F2), when the shift signal NEXT is controlled to be a valid level, the frequency control signal CTRL is an invalid level, and at this time, the signal of the seventh node N7 is an invalid level, so that the shift register cannot output the valid level of the gate driving signal. That is, in this time period, the gate driving signal output by the shift register is an invalid level, so that the pixel drive circuit connected to the shift register cannot perform signal refresh. In this way, different display areas may be controlled to be refreshed with different refresh frequencies.

Referring to FIGS. 4, 9, 10 and 11, at a certain moment of the circuit, for example, when the input signal IN is at a high level and the first clock signal CK is at a low level, the transistor T15 is turned on, the transistor T17 is normally turned on, and the low-level signal VGL will be transmitted to the gate of the transistor T18 through the transistors T15 and T17, so that the transistor T18 is turned on. At the moment when the second clock signal XCK leaps from a high level to a low level, the low-level signal of the second clock signal XCK will be transmitted to the gate of the transistor T19, so that the transistor T19 is turned on, and the low-level signal of the first electrode of the transistor T18 will be transmitted to the first node N1. When the second clock signal XCK is at a low level, the transistor T19 is turned on. Since the second electrode of the transistor T19 and the second electrode of the transistor T20 are connected together, considering the circuit coupling effect, the low-level signal of the second clock signal XCK will cause a certain coupling to the first voltage signal VGHA received by the transistor T20, so that the first voltage signal VGHA has a low-level glitch phenomenon. If the first electrode of the transistor T11 in the first output unit 20 is connected to a same voltage signal line as the first electrode of the transistor T20 in the first control unit 10, the voltage signal received by the transistor T11 will also have a low-level glitch phenomenon. When the transistor T11 is turned on, the stage transfer signal originally output by the transistor T11 should be a stable high-level signal, but due to the coupling interference of the low-level signal of the second clock signal XCK, a low-level glitch phenomenon will also appear in the stage transfer signal output by the transistor T11. Considering that the gating unit 30 needs to output the gate driving signal according to the stage transfer signal NEXT and the frequency control signal CTRL, if the stage transfer signal has a low-level glitch, it will affect the gate driving signal output by the gating unit 30. For example, if the stage transfer signal NEXT is a constant high-level signal, it cannot control the isolation protection unit 301 in the gating unit 30 to be turned on. If the stage transfer signal NEXT has an unexpected low-level glitch, the low-level glitch will cause the isolation protection unit 301 to be accidentally turned on. At this moment, when the frequency control signal CTRL leaps from a high level to a low level, the low-level frequency control signal will be transmitted to the output control unit 302, causing the output control unit 302 to be abnormally turned on. The low-level signal of the first node N1 will cause the transistor T1 in the second output unit 32 to be turned on, causing the shift register 01 to abnormally output a high-level signal. However, when the shift register 01 outputs a high-level signal, the corresponding pixel driving circuit will drive a light-emitting element to emit light abnormally, which is very likely to cause the corresponding light-emitting element to be burned and abnormal dark lines to appear on the display screen, affecting the display effect.

Accordingly, in the embodiments of the present disclosure, the first voltage signal VGHA corresponding to the first control unit 10 is transmitted by a first voltage signal line, and the third voltage signal VGHD corresponding to the first output unit 20 is transmitted a the second voltage signal line. The level type of the first voltage signal VGHA and the third voltage signal VGHD is the same. That is, both are high-level signals or both are low-level signals (the disclosed embodiment is described by taking the high-level signal as an example), but the two are transmitted by different voltage signal lines. When the coupling of the clock signal affects the first voltage signal, since the third voltage signal VGHD is transmitted by the second signal line, the third voltage signal VGHD will not be affected by the coupling of the clock signal. When the stage transfer signal output by the first output unit 20 is the third voltage signal VGHD, the third voltage signal VGHD is a stable voltage signal transmitted by the second signal line, and will not affect the accuracy of the stage transfer signal. Therefore, the present disclosure discloses a method in which different voltage signal lines are introduced into the first control unit 10 and the first output unit 20 to transmit the first voltage signal VGHA and the third voltage signal VGHD of the same level type, which helps improve the transmission accuracy of the stage transfer signal, and further improve the accuracy of the gate driving signal output by the gate drive circuit 00. This also helps avoid the problem of abnormal dark lines caused by burning of the light-emitting elements due to abnormal output of the gate driving signal, and thus helps improve the overall display effect of the display panel.

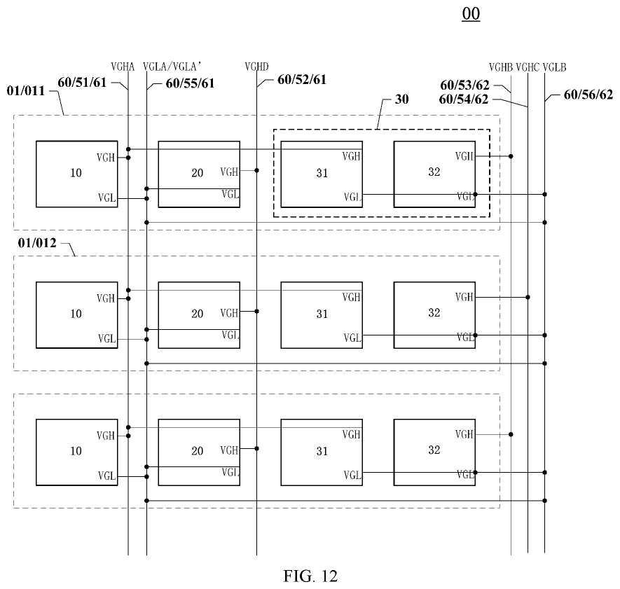

FIG. 12 is a schematic diagram showing a connection between shift registers 01 and voltage signal lines. Referring to FIG. 12, in some embodiments, in the N stages of shift registers 01 cascaded with each other, the first control units 10 in different shift registers 01 are connected to a same first voltage signal line 51.

Referring to FIGS. 10-12, optionally, a gating unit 30 includes a second control unit 31 and a second output unit 32. The second control unit 31 is configured to control the signal of the fifth node N5 at least according to the stage transfer signal NEXT, the frequency control signal CTRL and the first voltage signal VGHA. The second output unit 32 controls the output of the gate driving signal at least according to the signal of the fifth node N5 and the signal of the second node N2. It should be noted that, in order to clearly illustrate the connection relationship between the shift registers 01 and the voltage signal lines 60, FIG. 12 merely illustrates the connection relationship between the first control units 10, the first output units 20, the second control units 31 and the second output units 32 in three stage shift registers 01 and the voltage signal lines 60, and does not show other signal lines, and does not limit the number of shift registers 01 actually included in the gate driving circuit. In a same gate driving circuit, the connection relationship between other shift registers 01 and the voltage signal lines 60 may refer to FIG. 12.

The first voltage signal line 51 is used to transmit the first voltage signal VGHA to the first control unit 10 in a shift register 01. In some embodiments, when the first control units 10 in different shift registers 01 are connected to the same first voltage signal line 51, there is no need to introduce different voltage signal lines for different shift registers 01 to transmit the first voltage signal VGHA to different shift registers 01. The same first voltage signal line 51 may be used to transmit the first voltage signal VGHA to different shift registers 01. This helps reduce the number of voltage signal lines corresponding to the gate drive circuit 00 as a whole and simplify the wiring of the display panel.

Optionally, the disclosed embodiments are explained by taking the example that in a same shift register 01, the first control unit 10 and the second control unit 31 in the gating unit 30 are connected to a same first voltage signal line 51. In this way, the first control unit 10 and the second control unit 31 in different shift registers 01 correspond to a same first voltage signal line, which helps further reduce the number of voltage signal lines corresponding to the gate drive circuits 00, and also helps simplify the wiring of the display panel.

Referring continuously to FIG. 12, in some embodiments, in the mutually cascaded shift registers 01, the first output units 20 in different shift registers 01 are connected to a same second voltage signal line 52.

In order to avoid the coupling effect of the clock signal on the voltage signal received by the first output unit 20, a second voltage signal line 52 is introduced in the embodiments of the present disclosure, and the second voltage signal line 52 is used to provide a third voltage signal VGHD to the first output units 20 in the shift registers 01. When different shift registers 01 in a same gate drive circuit 00 correspond to a same second voltage signal line 52, and the third voltage signal VGHD is transmitted to the first output units 20 in different shift registers 01 through the same second voltage signal line 52. There is no need to introduce different voltage signal lines for different shift registers 01 to transmit the third voltage signal VGHD, which helps reduce the number of voltage signal lines corresponding to the gate drive circuits 00, and helps simplify the wiring of the display panel.

In some embodiments, a first control unit 10 at least receives the first voltage signal VGHA to control the signals of the first node N1 and the second node N2, and a first output unit 20 at least controls the stage transfer signal according to the signal of the first node N1, the signal of the second node N2 and the third voltage signal VGHD. When the first voltage signal line 51 and the second voltage signal line 52 are introduced in the embodiments of the present disclosure to transmit the first voltage signal VGHA and the third voltage signal VGHD, the first voltage signal VGHA and the third voltage signal VGHD are signals of the same level type. That is, both are high-level signals or both are low-level signals. On this basis, in some embodiments, the voltage values of the first voltage signal VGHA and the third voltage signal VGHD are the same. The voltage signals on the display panel are usually provided by the chip. For example, a binding pad may be set on the display panel to bind the chip or the flexible circuit board. A voltage signal is transmitted to a voltage signal line through the binding pad, and then transmitted to a gate drive circuit 00 or the pixel drive circuits in the panel. When the voltage values of the first voltage signal VGHA corresponding to the first control units 10 and the third voltage signal VGHD corresponding to the first output units 20 in the gate driving circuits 00 are the same, the first voltage signal line 51 transmitting the first voltage signal VGHA and the second voltage signal line 52 transmitting the third voltage signal VGHD may be connected to a same binding pad, which helps reduce the number of binding pads and the number of pads on the chip, thereby helping simplify chip design.

Apparently, in some embodiments, when the voltage values of the first voltage signal VGHA and the third voltage signal VGHD are the same, the first voltage signal line 51 and the second voltage signal line 52 may also be connected to different binding pads, and the voltage values of the voltage signals transmitted by different binding pads are the same, which is not limited in the present disclosure.

It should be noted that the voltage values of the first voltage signal VGHA and the third voltage signal VGHD mentioned in the embodiments of the present disclosure are the same, which means that the voltage values of the two are the same when the first voltage signal is not affected by the coupling of the clock signal, or the voltage value of the voltage signal transmitted by the binding pad connected to the first voltage signal line 51 and the second voltage signal line 52 is the same.

Referring continuously to FIG. 12, in some embodiments, the second voltage signal VGLA and the fourth voltage signal VGLA′ are signals with the same voltage value and are provided by a same voltage signal line 60. The voltage signal line 60 here is the fifth voltage signal line 55.

In some embodiments, the second voltage signal VGLA is a low-level signal provided to a first control unit 10, and the fourth voltage signal VGLA′ is a low-level signal provided to a first output unit 20. When the second voltage signal VGLA and the fourth voltage signal VGLA′ are set to signals with the same voltage value provided by the same voltage signal line 60, there is no need to introduce different voltage signal lines for the first control unit 10 and the first output unit 20 to transmit the low-level signal, which helps simplify the number of voltage signal lines corresponding to the gate drive circuits 00.

In some embodiments, the fourth voltage signal VGLA′ corresponds to an invalid-level signal in the stage transfer signal. In other words, the fourth voltage signal VGLA′ is output as an invalid-level signal in the stage transfer signal.

Optionally, in a same gate driving circuit 00, the first control unit 10 and the first output unit 20 of different cascaded shift registers 01 are connected to a same fifth voltage signal line 55, and the second voltage signal VGLA and the fourth voltage signal VGLA′ with a same voltage value may be provided to different shift registers 01 through the fifth voltage signal line 55. There is no need to introduce different voltage signal lines for different shift registers 01, which helps reduce the number of voltage signal lines connected to the gate driving circuit and simplify the wiring of the display panel.

It should be noted that, in some embodiments, the second voltage signal VGLA and the fourth voltage signal VGLA′ may also be signals with the same level type but different voltage values. Alternatively, the second voltage signal VGLA and the fourth voltage signal VGLA′ may also be signals with the same voltage value provided by different voltage signal lines, which is not specifically limited in the present disclosure.

Optionally, in the embodiments of the present disclosure, the first voltage signal and the third voltage signal are both high-level signals, and the second voltage signal and the fourth voltage signal are both low-level signals are used as an example for illustration, but the present disclosure is not limited thereto. In some embodiments, the first voltage signal and the third voltage signal may also be low-level signals, and the second voltage signal and the fourth voltage signal may also be high-level signals.

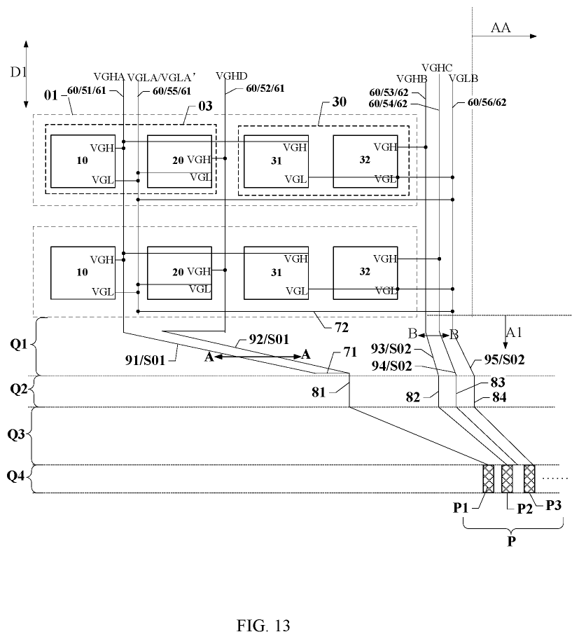

FIG. 13 is a schematic diagram showing a connection between voltage signal lines and fan-out lines in the display panel provided by the embodiments of the present disclosure. It should be noted that FIG. 13 merely shows the connection relationship between the voltage signal lines, connected to the gate drive circuit(s) 00, and the fan-out lines, and does not show the connection relationship between other lines in the display panel and the fan-out lines. For the connection relationship between other lines such as data lines and fan-out lines, reference may be made to related technologies, which is not specified in the present. Referring to FIGS. 1 and 13, in some embodiments, the display panel 100 includes a display area AA and a first non-display area A1 located on one side of the display area along a first direction D1, the first non-display area includes a fan-out area Q1 and a bending area Q2, the fan-out area Q1 is located between the bending area Q2 and the display area AA. The fan-out area Q1 includes a first fan-out line 91 and a second fan-out line 92, the first fan-out line 91 is electrically connected to the first voltage signal line 51, and the second fan-out line 92 is electrically connected to the second voltage signal line 52. The bending area Q2 includes a first lead 81, and the first fan-out line 91 and the second fan-out line 92 are electrically connected to the same first lead 81.

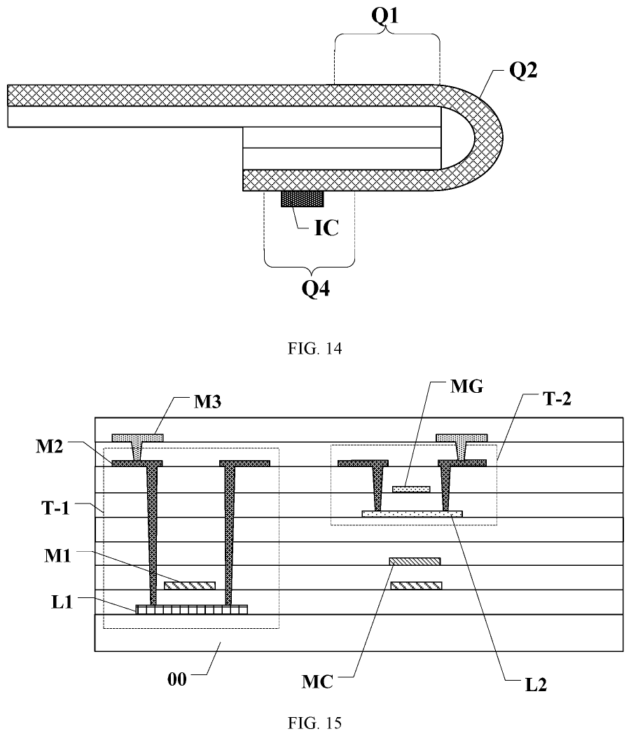

Optionally, the display panel in accordance with an embodiment of the present disclosure is a flexible display panel, and the flexible display panel may be bent through the bending area Q2, and at least some of the components may be bent to the backlight surface of the display panel to reduce the border width of the display panel. FIG. 13 illustrates the non-divided area of the display panel that has not been bent. The structural diagram of the display panel after bending may refer to FIG. 14, where FIG. 14 shows a structural schematic diagram of the display panel after being bent through the bending area Q2 in accordance with an embodiment of the present disclosure. Optionally, a pad area Q4 is provided on the side of the bending area Q2 away from the fan-out area Q1, and the pad area Q4 is used to bind to the control chip IC or to bind to the flexible circuit board. In this way, the pad area Q4 will not occupy the space on the side of the light-emitting surface of the display panel, so it is conducive to realizing the narrow border design of the display panel.

Referring continuously to FIGS. 13 and 14, the fan-out area Q1 in the first non-display area is adjacent to the display area in the display panel. The bending area Q2 is located on the side of the fan-out area Q1 away from the display area, and the display panel may be bent through the bending area Q2. The pad area Q4 is located on the side of the bending area Q2 away from the fan-out area Q1. The pad area Q4 includes a plurality of binding pads P. After the pad area Q4 is bound to the control chip IC, the control chip IC may provide power signals, data signals and other signals through the binding pads P. It should be noted that FIG. 13 merely illustrates the binding pads connected to some voltage signal lines, and does not show other binding pads. In fact, there are other binding pads in the pad area Q4. In order to realize the connection between the first voltage signal line 51 and the second voltage signal line 52 and the binding pad P, a first fan-out line 91 connected to the first voltage signal line 51 and a second fan-out line 92 connected to the second voltage signal line 52 are introduced in the pad area Q4 in the disclosed embodiment. Considering that the extension direction of a fan-out line of the fan-out area Q1 is not unique, and most of them converge from two sides of the fan-out area Q1 to the middle area, if the fan-out area Q1 is bent, there may be a risk of disconnection. Therefore, a bending area Q2 is further introduced in the embodiments of the present disclosure, and a first lead 81 is introduced in the bending area Q2, and a fan-out line is electrically connected to the binding pad P in the pad area Q4 through the first lead 81. Optionally, the first lead 81 extends along the first direction D1, following the bending direction of the bending area Q2, so as to help avoid the problem of disconnection due to bending.

In the disclosed embodiment, the first voltage signal line 51 is electrically connected to the first fan-out line 91, the second voltage signal line 52 is electrically connected to the second fan-out line 92, and the first fan-out line 91 and the second fan-out line 92 are electrically connected to the same first lead 81 in the bending area Q2. In this way, voltage signals with the same voltage value may be transmitted to the first fan-out line 91 and the second fan-out line 92 respectively through the first lead 81, and further transmitted to the first voltage signal line 51 and the second voltage signal line 52. The voltage signal transmitted through the first voltage signal line 51 is the first voltage signal VGHA in the disclosed embodiments, and the voltage signal transmitted through the second voltage signal line 52 is the third voltage signal VGHD in the disclosed embodiments. Since the first voltage signal line 51 and the second voltage signal line 52 are connected to the same first lead 81, the voltage value of the first voltage signal VGHA and the voltage value of the third voltage signal VGHD are the same. The method of connecting the same first lead 81 may also reduce the number of leads in the bending area Q2 and simplify the wiring structure of the bending area Q2.

Referring continuously to FIG. 13, in some embodiments, the ends of the first fan-out line 91 and the second fan-out line 92 away from the display area are electrically connected through a first connection portion 71, and the first connection portion 71 is located in the fan-out area Q1. Since the first fan-out line 91 and the second fan-out line 92 are electrically connected to the same first lead 81 of the bending area Q2, the first fan-out line 91 and the second fan-out line 92 may be electrically connected before being electrically connected to the first lead 81. The illustrated embodiment is described by a scheme of electrically connecting the ends of the first fan-out line 91 and the second fan-out line 92 close to the bending area Q2 through the first connection portion 71, and the first connection portion 71 is located in the fan-out area Q1. Considering that the extension direction of the first connection portion 71 used to connect the first fan-out line 91 and the second fan-out line 92 is not the first direction D1, if the first connection portion 71 is set in the bending area Q2, there may be a risk of disconnection. Therefore, in the disclosed embodiment, the first connection portion 71 is set in the fan-out area Q1 without bending, which helps reduce the risk of disconnection in the bending area Q2. In addition, if the first fan-out line 91 and the second fan-out line 92 are not located in the same metal layer, when the first fan-out line 91 and the second fan-out line 92 are electrically connected through the first connecting portion 71, it is necessary to achieve electrical connection through punching. Therefore, when the first connecting portion 71 is located in the fan-out area Q1, the corresponding connection hole will also be located in the fan-out area Q1, which also helps avoid the risk of breaking the connection hole if the connection hole is set in the bending area Q2.

It should be noted that, in some embodiments, if there is sufficient space in the display panel, two leads may be provided in the bending area to be electrically connected to the first fan-out line 91 and the second fan-out line 92 respectively, which is not specifically limited in the present disclosure.

FIG. 15 is a schematic diagram of film layers of a display panel in accordance with an embodiment of the present disclosure. This illustrated embodiment illustrates a feasible film layer structure of driving function layers on the display panel, but the disclosure is not limited to the disclosed embodiment. Referring to FIG. 15, optionally, the driving function layers include a first active layer L1, a first metal layer M1, a capacitor metal layer MC, a second active layer L2, a gate metal layer MG, a second metal layer M2 and a third metal layer M3 disposed on the same side of the substrate 00. In some embodiments, the display panel may also include a fourth metal layer disposed on the side of the third metal layer M3 away from the substrate. Optionally, the display panel includes a P-type transistor T-1 and an N-type transistor T-2. The material of the first active layer L1 of the P-type transistor T-1 is polysilicon, and the material of the second active layer L2 of the N-type transistor T-2 is a metal oxide, such as IGZO, IZO, etc. The gate of the P-type transistor T-1 may be located in the first metal layer M1, and the source and drain may be located in the second metal layer M2 and/or the third metal layer M3 for exemplary purposes. The gate of the N-type transistor T-2 may be located in the gate metal layer MG, and the source and drain may be located in the second metal layer M2 and/or the third metal layer M3 for exemplary purposes. In the display panel, the first metal layer M1, the gate metal layer MG and the second metal layer M2 may also be provided with a plurality of signal lines, and similarly the third metal layer M3 and the capacitor metal layer MC may both be used for the layout of the signal lines. The capacitor metal layer MC is also configured to overlap with the second metal layer M2 or the first metal layer M1 to form a storage capacitor in a pixel driving circuit.

Referring continuously to FIGS. 13 and 15, signal lines may be laid out in the metal film layers in the display panel. Since the voltage signal lines, data lines and other signal lines in the display panel need to be connected to the binding pads through the fan-out lines in the fan-out area Q1, the number of fan-out lines in the fan-out area Q1 will be relatively large. In some embodiments, the first fan-out line 91 connected to the first voltage signal line 51 and the second fan-out line 92 connected to the second voltage signal line 52 are located in different film layers. The first voltage signal line 51 and the second voltage signal line 52 connected to a same gate drive circuit 00 may be disposed adjacent to each other in the display panel. In this way, in the fan-out area Q1, the first fan-out line 91 and the second fan-out line 92 will also be disposed adjacent to each other. Considering that there are many fan-out lines in the fan-out area Q1 and the space is limited, the first fan-out line 91 and the second fan-out line 92 may be respectively disposed in different metal layers to avoid the problem of short circuit between the first fan-out line 91 and the second fan-out line 92 due to the close distance. This helps improve the stability of the signals transmitted by the first fan-out line 91 and the second fan-out line 92.

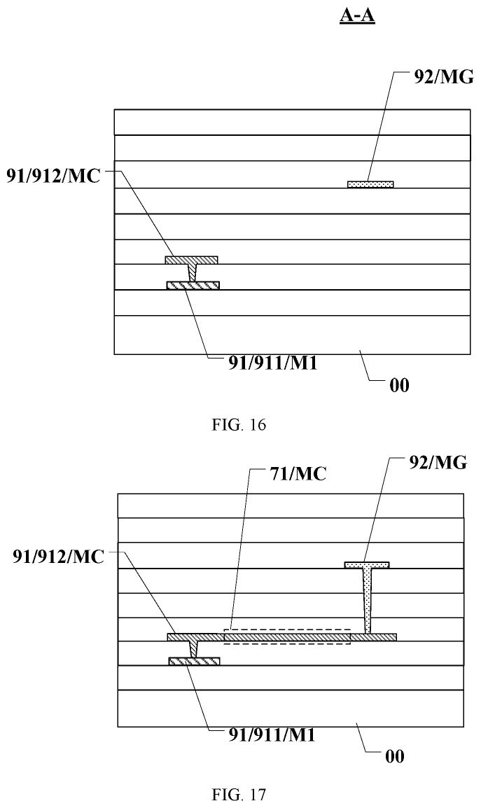

FIG. 16 is a cross-sectional view of FIG. 13 in the direction of AA, illustrating the film layer relationship of the first fan-out line 91, the first connection portion 71, and the second fan-out line 92. Referring to FIG. 16, in some embodiments, the first fan-out line 91 includes a first sub-line 911 and a second sub-line 912 that are electrically connected, and the first sub-line 911 and the second sub-line 912 are disposed in different layers.

The embodiment shown in FIG. 16 is described by taking the first sub-line 911 located in the first metal layer M1 and the second sub-line 912 located in the capacitor metal layer MC as an example, but the present disclosure is not limited thereto. In some embodiments, the first sub-line 911 and the second sub-line 912 may also be located in other metal layers on the display panel. When the first fan-out line 91 is configured to adopt a double-layer wiring method of the first sub-line 911 and the second sub-line 912, the first sub-line 911 and the second sub-line 912 may be connected in parallel, which helps reduce the overall impedance of the first fan-out line 91 and improving the signal transmission efficiency on the first fan-out line 91.

Referring to FIGS. 4 and 13, the first control unit 10 and the second control unit 31 in a shift register 01 are both electrically connected to the first voltage signal line 51, and the first voltage signal VGHA is obtained through the first voltage signal line 51. Therefore, the load corresponding to the first voltage signal line 51 is relatively large. When the first fan-out line 91 electrically connected to the first voltage signal line 51 is wired in a double-layer wiring manner, it helps reduce the impedance of the first fan-out line 91, improve the transmission efficiency of the first voltage signal VGHA on the first fan-out line 91, and reduce the difference in the first voltage signal VGHA received by different shift registers 01, thereby improving the working stability of different shift registers 01. In some embodiments, if the display panel space is sufficient, the first fan-out line 91 may also be wired in a three-layer wiring manner, which is not specifically limited in the present disclosure.

Referring to FIG. 13 and FIG. 16, optionally, considering that the second voltage signal line 52 is a voltage signal line introduced separately for the first output unit 20 in a shift register 01, the second voltage signal line 52 may be electrically connected just to the first output unit 20 in the shift register 01, so the load of the second voltage signal line 52 is relatively small. Further considering that the space in the fan-out area Q1 is limited, the second fan-out line 92 corresponding to the second voltage signal line 52 may be wired in a single-layer routing manner. This illustrated embodiment shows a solution in which the second fan-out line 92 is set in the gate metal layer MG, but the present disclosure is not limited thereto. In some embodiments, the second fan-out line 92 may also be set in other metal layers. Apparently, if the wiring space in the fan-out area Q1 is sufficient, the second fan-out line 92 may be wired in a double-layer wiring or a three-layer wiring manner to reduce the overall impedance of the second fan-out line 92 and improve the stability of the third voltage signal transmitted by the second fan-out line 92.

FIG. 17 is a schematic diagram of film layers in which the first voltage signal line 51 and the second voltage signal line 52 are connected via a first connecting portion 71. Referring to FIG. 13 and FIG. 17, when the first sub-line 911 and the second sub-line 912 in the first fan-out line 91 are respectively located in the first metal layer M1 and the capacitor metal layer MC and the second fan-out line 92 is located in the gate metal layer MG, the first connecting portion 71 connecting the first fan-out line 91 and the second fan-out line 92 may be set in the capacitor metal layer MC, directly connected to the second sub-line 912 in the first fan-out line 91, and electrically connected to the second fan-out line 92 through a connecting hole. This helps reduce the difficulty of connecting the first fan-out line 91 and the second fan-out line 92. However, the present disclosure is not limited in the disclosed embodiment. In some embodiments, the first connecting portion 71 may also be set in other feasible metal layers according to actual needs, for example, may be located in the first metal layer M1.

The embodiment shown in FIGS. 16 and 17 illustrates a solution in which the first fan-out line 91 and the second fan-out line 92 do not overlap along a direction perpendicular to the plane where the substrate 00 is located, but the present disclosure is not limited thereto. In some embodiments, the first fan-out line 91 and the second fan-out line 92 may also overlap along a direction perpendicular to the plane where the substrate 00 is located. For example, refer to FIG. 18, which is a schematic diagram of film layers of the first fan-out line 91 and the second fan-out line 92 in FIG. 13. Consider that the first fan-out line 91 is electrically connected to the first voltage signal line 51, and the second fan-out line 92 is electrically connected to the second voltage signal line 52, and the first voltage signal VGHA and the third voltage signal VGHD respectively transmitted by the first voltage signal line 51 and the second voltage signal line 52 are signals of the same level type. Optionally, the voltage values of the first voltage signal VGHA and the third voltage signal VGHD are the same. Therefore, when the first fan-out line 91 and the second fan-out line 92 are set to overlap, the signals transmitted by the first fan-out line 91 and the second fan-out line 92 will not cause mutual coupling interference. At the same time, the overlapping setting of the first fan-out line 91 and the second fan-out line 92 also helps reduce the actual space width occupied by the first fan-out line 91 and the second fan-out line 92 in the fan-out area (specifically referring to the space width parallel to the plane where the substrate 00 is located), which helps achieve a narrow border width of the display panel.

Referring continuously to FIG. 13, in some embodiments, the first non-display area includes a pad area Q4, and the pad area Q4 is located on the side of the bending area Q2 away from the display area. The pad area Q4 includes a plurality of binding pads P, and the binding pads P include a first binding pad P1. The first lead 81 is electrically connected to the first binding pad P1. The binding pads P in the pad area Q4 are configured to be electrically connected to the control chip or the flexible circuit board, so that the control chip may transmit signals to the signal lines in the display panel through the binding pads. In the disclosed embodiment, the first voltage signal line 51 and the second voltage signal line 52 are electrically connected to the first fan-out line 91 and the second fan-out line 92 in the fan-out area Q1, respectively. The first fan-out line 91 and the second fan-out line 92 are electrically connected to the same first lead 81 in the bending area Q2. The first lead 81 is electrically connected to the first binding pad P1. In this way, the electrical connection between the first binding pad P1 and the first voltage signal line 51 and the second voltage signal line 52 is realized. The corresponding voltage signal may be transmitted to the first voltage signal line 51 and the second voltage signal line 52 through the first binding pad P1, so that the voltage values of the first voltage signal VGHA transmitted by the first voltage signal line 51 and the third voltage signal VGHD transmitted by the second voltage signal line 52 are the same. Therefore, there is no need to introduce different binding pads for the first voltage signal line 51 and the second voltage signal line 52, respectively, which helps reduce the number of binding pads in the pad area Q4, so as to reduce the number of pads in the control chip bound to the binding area, so it helps simplify the chip structure and reduce production costs.

Referring to FIGS. 4 and 10, in some embodiments, a gating unit 30 includes a second control unit 31 and a second output unit 32. The second control unit 31 is configured to control the signal of the fifth node N5 at least according to the first voltage signal VGHA, the signal of the first node N1, the stage transfer signal NEXT and the frequency control signal CTRL. The second output unit 32 is configured to output a gate driving signal at least according to the signals of the fifth node N5 and the second node N2.

In the disclosed embodiment, the second control unit 31 in the gating unit 30 receives the first voltage signal VGHA and may be connected to the same first voltage signal line 51 as the first control unit 10. There is no need to introduce a separate voltage signal line for transmitting a high voltage signal for the second control unit 31, which helps reduce the number of voltage signal lines connected to a gate drive circuit 00 and simplify the wiring difficulty of the display panel.

It should be noted that when the display panel space is sufficient, a voltage signal line for transmitting a high voltage signal may be introduced for the second control unit 31 to avoid mutual influence of high voltage signals received by different units in a shift register 01, so as to improve the accuracy of the signals of each unit of the shift register 01.

Referring to FIGS. 4 and 12, in some embodiments, the mutually cascaded N stages of shift registers 01 include a first shift register 011 and a second shift register 012. The second output unit 32 of the first shift register 011 is configured to output a gate driving signal according to the fifth voltage signal VGHB, the sixth voltage signal VGLB and the signal of the second node N2, and the second output unit 32 of the second shift register 012 is configured to output a gate driving signal according to the seventh voltage signal VGHC, the sixth voltage signal VGLB and the signal of the second node N2. The fifth voltage signal VGHB, the seventh voltage signal VGHC and the third voltage signal VGHD are signals of a same level type. The sixth voltage signal VGLB, the fourth voltage signal VGLA′ and the second voltage signal VGLA are signals of a same level type.

Referring continuously to FIG. 12, the cascaded N stages of shift registers 01 include a first shift register 011 and a second shift register 012. Optionally, the first shift register 011 is located at an odd-numbered stage, and the second shift register 012 is located at an even-numbered stage. Alternatively, the first shift register 011 is located at an even-numbered stage, and the second shift register 012 is located at an odd-numbered stage. The illustrated embodiment is described by taking the first shift register 011 being located at an odd-numbered stage and the second shift register 012 being located at an even-numbered stage as an example.

For each first shift register 01 in a same gate drive circuit 00, its second output unit 32 is connected to a same third voltage signal line 53, which is configured to transmit the fifth voltage signal VGHB to the second output unit 32. For each second shift register 01 in a same gate drive circuit 00, its second output unit 32 is connected to a same fourth voltage signal line 54, which is configured to transmit the seventh voltage signal VGHC to the second output unit 32. When the first shift register 01 needs to transmit the valid-level signal in the gate driving signal to the corresponding scan line, the fifth voltage signal VGHB will be able to be transmitted to the output terminal of the shift register 01 and output as the gate driving signal. When the second shift register 01 needs to transmit the valid-level signal in the gate driving signal to the corresponding scan line, the seventh voltage signal VGHC will be able to be transmitted to the output terminal of the shift register 01 and output as the gate driving signal. If the third output modules 311 of the shift registers 01 of odd and even stages are connected to a same voltage signal line, considering that the gate driving signal output by a shift register 01 leaps from a high level to a low level, due to the coupling of the signal, the voltage signal on the voltage signal line connected to the third output module 311 in the gating unit 30 will be affected, resulting in ripples or glitches on the signal on the voltage signal line. Since the gate driving signal output by each stage of shift register 01 will have a corresponding coupling effect in the process of leaping from a high level to a low level, the voltage signal on the voltage signal line will repeatedly have ripples or glitches. Therefore, the present disclosure discloses a method in which a third voltage signal line 53 and a fourth voltage signal line 54 are introduced into the first shift register 01 and the second shift register 01 respectively to transmit the fifth voltage signal VGHB and the seventh voltage signal VGHC respectively. The ripples or glitches on the third voltage signal line 53 due to coupling will be halved, and the ripples or glitches on the fourth voltage signal line 53 due to coupling will also be halved, so the impact on the signals on the third voltage signal line 53 and the fourth voltage signal line 54 will also be reduced. For adjacent odd-level and even-stage shift registers, since the third output modules 311 of the two are connected to different voltage signal lines, the signals of the two will not affect each other, so it helps improve the stability of the gate driving signal output by the gating unit 30.

In the present disclosure, the fifth voltage signal VGHB, the seventh voltage signal VGHC and the third voltage signal VGHD are signals of the same level type. Optionally, the fifth voltage signal VGHB, the seventh voltage signal VGHC, the third voltage signal VGHD and the first voltage signal VGHA are high-level signals. The sixth voltage signal VGLB, the fourth voltage signal VGLA′ and the second voltage signal VGL A are signals of the same level type. Optionally, the sixth voltage signal VGLB, the fourth voltage signal VGLA′ and the second voltage signal VGLA are low-level signals. By setting the fifth voltage signal VGHB, the seventh voltage signal VGHC, the third voltage signal VGHD and the first voltage signal VGHA as high-level signals, and setting the sixth voltage signal VGLB, the fourth voltage signal VGLA′ and the second voltage signal VGLA as low-level signals, the gate driving signal output by the shift register 01 may be controlled. Apparently, in some embodiments, the fifth voltage signal VGHB, the seventh voltage signal VGHC, the third voltage signal VGHD and the first voltage signal VGHA may also be low-level signals, and the sixth voltage signal VGLB, the fourth voltage signal VGLA′ and the second voltage signal VGLA may also be high-level signals, which is not specifically limited in the present disclosure.

Referring continuously to FIG. 13, in some embodiments, the voltage signal lines 60 in the display panel further include a third voltage signal line 53 and a fourth voltage signal line 54. The third voltage signal line 53 is used to transmit the fifth voltage signal VGHB, and the fourth voltage signal line 54 is used to transmit the seventh voltage signal VGHC. The method of introducing different voltage signal lines for the odd-numbered shift registers and the even-numbered shift registers to transmit the fifth voltage signal VGHB and the seventh voltage signal VGHC of the same level type is conducive to avoiding the mutual influence of the signals received by the odd-numbered shift registers and the even-numbered shift registers, thereby helping to improve the accuracy of the gate driving signal output by the shift register.

Referring to FIG. 13, in some embodiments, the fifth voltage signal VGHB, the seventh voltage signal VGHC, the third voltage signal VGHD and the first voltage signal VGHA have the same voltage value, and/or the sixth voltage signal VGLB, the fourth voltage signal VGLA′ and the second voltage signal VGLA have the same voltage value.

When the voltage values of the fifth voltage signal VGHB, the seventh voltage signal VGHC, the third voltage signal VGHD and the first voltage signal VGHA are set to the same, the voltage signal lines corresponding to these voltage signals may be connected to a same binding pad through fan-out lines, and these voltage signals may be transmitted to the shift register 01 through the same binding pad, which helps reduce the number of binding pads included in the pad area Q4, simplify the chip structure, and reduce the chip production cost.

Optionally, the fifth voltage signal VGHB, the seventh voltage signal VGHC, the third voltage signal VGHD and the first voltage signal VGHA are high-level signals, and these high-level signals with the same voltage value may be transmitted to the shift register 01 through the same binding pad, which is conducive to unified control of the high-level signals.

It should be noted that, in some embodiments, when the fifth voltage signal VGHB, the seventh voltage signal VGHC, the third voltage signal VGHD and the first voltage signal VGHA are all high-level signals, the voltage values of these voltage signals may be set to be not completely the same. At this moment, voltage signals with different voltage values may be transmitted by different binding pads, which is not specifically limited in the present disclosure.

Similarly, when the voltage values of the sixth voltage signal VGLB, the fourth voltage signal VGLA′ and the second voltage signal VGLA are set to the same, the voltage signal lines corresponding to these voltage signals may be connected to a same binding pad through fan-out lines, and these voltage signals may be transmitted to the shift registers 01 through the same binding pad, which also helps reduce the number of binding pads included in the pad area Q4, simplify the chip structure, and reduce the chip production cost.

Optionally, the sixth voltage signal VGLB, the fourth voltage signal VGLA′ and the second voltage signal VGLA are low-level signals, and these low-level signals with the same voltage value may be transmitted to the shift register 01 through the same binding pad, which is conducive to unified control of high-level signals.

It should be noted that when the sixth voltage signal VGLB, the fourth voltage signal VGLA′ and the second voltage signal VGLA are all low-level signals, the voltage values of these voltage signals may be set to be unequally identical or different. At this moment, voltage signals with different voltage values may be transmitted by different binding pads, which is not specifically limited in the present disclosure.

Referring continuously to FIGS. 1 and 13, in some embodiments, the display panel includes a display area AA and a first non-display area A1 located on one side of the display area AA along a first direction D1. The first non-display area A1 includes a fan-out area Q1 and a bending area Q2, and the fan-out area Q1 is located between the bending area Q2 and the display area. The fan-out area Q1 includes a third fan-out line 93 and a fourth fan-out line 94, the third fan-out line 93 is electrically connected to the third voltage signal line 53, and the fourth fan-out line 94 is electrically connected to the fourth voltage signal line 54. The bending area Q2 includes a second lead 82 and a third lead 83, the second lead 82 is electrically connected to the third fan-out line 93, and the third lead 83 is electrically connected to the fourth fan-out line 94.

The third voltage signal line 53 is used to provide a voltage signal to the second output unit 32 in the odd-numbered shift registers 01, and the fourth voltage signal line 54 is used to provide a voltage signal to the second output unit 32 in the even-numbered shift registers 01. The third voltage signal line 53 is electrically connected to the second lead 82 through the third fan-out line 93, and the fourth voltage signal line 54 is electrically connected to the third lead 83 through the fourth fan-out line 94. That is, the fan-out lines corresponding to the third voltage signal line 53 and the fourth voltage signal line 54 are wired separately, and the corresponding leads located in the bending area Q2 are also wired separately, which helps improve the stability and accuracy of the voltage signals transmitted to the third voltage signal line 53 and the fourth voltage signal line 54.

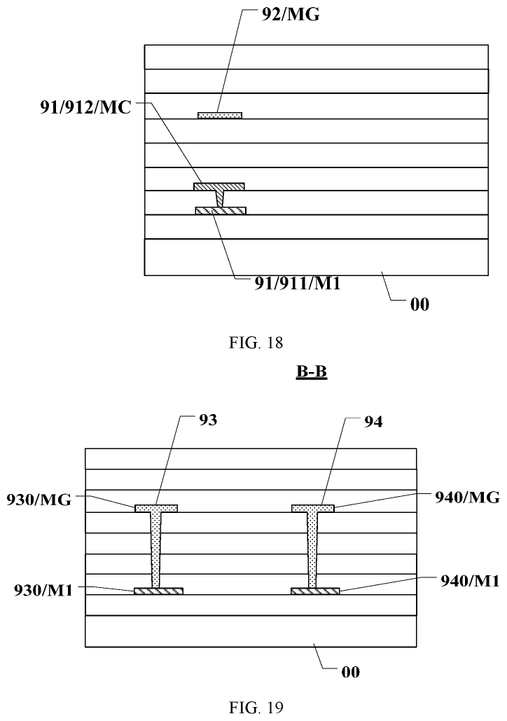

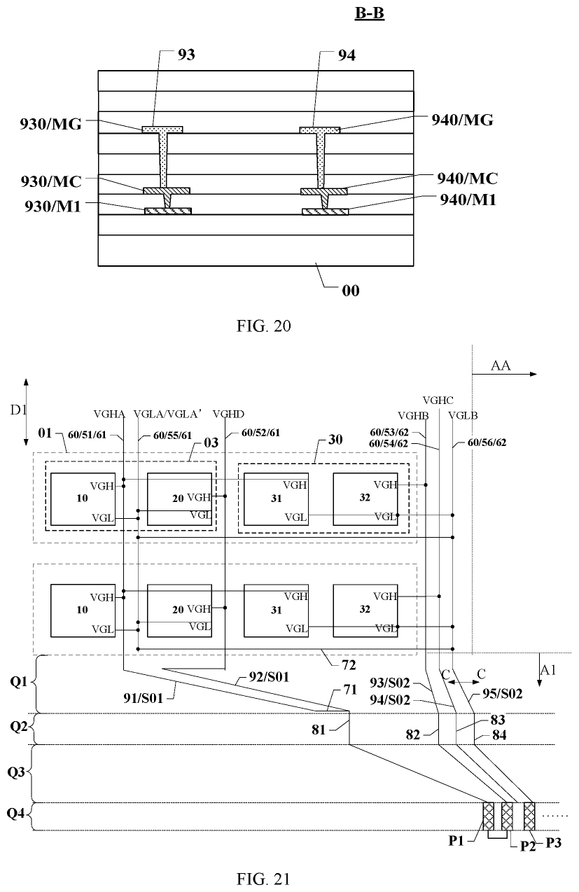

FIG. 19 shows a BB cross-sectional view of FIG. 13, and FIG. 20 shows another BB cross-sectional view of FIG. 13. Referring to FIGS. 15, 19 and 20, in some embodiments, the third fan-out line 93 includes at least two sub-fan-out lines 930 located in different metal layers and electrically connected, and the fourth fan-out line 94 includes at least two sub-fan-out lines 940 located in different metal layers and electrically connected.

Referring to FIG. 15, the metal film layers in the display panel, such as the gate metal layer MG, the first metal layer M1, the capacitor metal layer MC, the second metal layer M2 and the third metal layer M3, may all be used to lay out signal lines. In the fan-out area, the fan-out lines may be laid out in at least one of the gate metal layer MG, the capacitor metal layer MC and the first metal layer M1. The embodiment shown in FIG. 19 shows a structure in which both the third fan-out line 93 and the fourth fan-out line 94 are double-layered, and the embodiment shown in FIG. 20 shows a structure in which both the third fan-out line 93 and the fourth fan-out line 94 are three-layered. The embodiment shown in FIG. 19 is described by taking the manner in which the third fan-out line 93 and the fourth fan-out line 94 are respectively wired in parallel on the gate metal layer MG and the first metal layer M1 as an example, and the embodiment shown in FIG. 20 is described by taking the manner in which the third fan-out line 93 and the fourth fan-out line 94 are respectively wired on the gate metal layer MG, the capacitor metal layer MC and the first metal layer M1 as an example, but the present disclosure is not limited thereto. When the third fan-out line 93 and the fourth fan-out line 94 are double-layered or triple-layered, the corresponding routing may also be disposed in other film layers.

In the disclosed embodiment, the third fan-out line 93 and the fourth fan-out line 94 adopt a double-layer metal parallel routing method or a three-layer metal parallel routing method, which helps reduce the impedance of the third fan-out line 93 and the fourth fan-out line 94, thereby facilitating the improvement of the transmission efficiency of the voltage signal on the third fan-out line 93 and the fourth fan-out line 94. This reduces the difference in the fifth voltage signal received by different first shift registers 01, and at the same time, it helps reduce the difference in the seventh voltage signal received by different second shift registers 01, and helps improve the working stability and consistency of different shift registers 01.

Consider that the third fan-out line 93 and the fourth fan-out line 94 are electrically connected to the third voltage signal line 53 and the fourth voltage signal line 54 respectively, and the signals transmitted by the third voltage signal line 53 and the fourth voltage signal line 54 may be output to the pixel driving circuits as gate driving signals. When the third fan-out line 93 and the fourth fan-out line 94 correspond to three sub-fan-out lines respectively, it helps reduce the impedance of the third voltage signal line 53 and the fourth voltage signal line 54, and improve the transmission stability and accuracy of the corresponding voltage signals. At this moment, the three sub-fan-out lines corresponding to the third voltage signal line 53 and the fourth voltage signal line 54 respectively may be distributed in the first metal layer M1, the capacitor metal layer MC and the gate metal layer MG. Referring to FIGS. 13, 18 and 20, optionally, along the direction perpendicular to the substrate 00, the first fan-out line 91 and the second fan-out line 92 overlap in the orthographic projection of the plane where the substrate 00 is located, and the sub-fan-out lines corresponding to the first fan-out line are distributed in the capacitor metal layer MC and the first metal layer M1, and the second fan-out line 92 is distributed in the gate metal layer MG. That is, the first fan-out line 91 and the second fan-out line 92 are distributed as a whole in the first metal layer M1, the capacitor metal layer MC and the gate metal layer MG. This is conducive to the reasonable use of the space in the fan-out area to set the first fan-out line 91, the second fan-out line 92, the third fan-out line 93 and the fourth fan-out line 94, which ensures the reliable transmission of the signals on the fan-out line and is conducive to the narrow frame design of the display panel.

Referring continuously to FIG. 13, in some embodiments, the first non-display area includes a pad area Q4, and the pad area Q4 is located on the side of the bending area Q2 away from the display area. The pad area Q4 includes a plurality of binding pads P, and the binding pads P include a second binding pad P2, and the second lead 82 and the third lead 83 are electrically connected to the same second binding pad P2.

Optionally, a connection line area Q3 is further included between the bending area Q2 and the pad area Q4, and connection lines are provided in the connection line area Q3 for electrically connecting the binding pad P to the leads in the bending area Q2. The second lead 82 and the third lead 83 may correspond to different connection lines in the connection line area, and the connection lines corresponding to the second lead 82 and the third lead 83 may be electrically connected to the second binding pad P2 after forming an electrical connection in the wiring area Q3. By transmitting voltage signals to the third voltage signal line 53 and the fourth voltage signal line 54 respectively through a second binding pad P2, there is no need to introduce different binding pads for the third voltage signal line 53 and the fourth voltage signal line 54, which is conducive to reducing the number of binding pads in the pad area Q4. This is further conducive to reducing the number of pads in the control chip bound to the pad area Q4, thereby simplifying the chip structure and reducing the chip production cost. The method of separately wiring the third fan-out line 93 and the fourth fan-out line 94 corresponding to the third voltage signal line 53 and the fourth voltage signal line 54, and separately wiring the corresponding second lead 82 and the third lead 83 helps improve the stability and accuracy of the voltage signal transmitted to the third voltage signal line 53 and the fourth voltage signal line 54, and avoid signal interference in the odd-stage shift registers and the even-stage shift registers.

The embodiment shown in FIG. 13 shows a solution in which the first binding pad P1 and the second binding pad P2 are two independent pads. In this case, different high-voltage signals may be transmitted through the first binding pad P1 and the second binding pad P2, respectively. However, the present disclosure is not limited thereto. In some embodiments, the first binding pad P1 and the second binding pad P2 may also be electrically connected. For example, referring to FIG. 21, FIG. 21 is a schematic diagram showing another connection between the voltage signal lines and the fan-out lines in the display panel provided by the embodiments of the present disclosure. In the disclosed embodiment, the first binding pad P1 and the second binding pad P2 are electrically connected through a signal line, and the two have the same potential. In this way, the first binding pad P1 and the second binding pad P2 may provide voltage signals with the same voltage value to the first voltage signal line 51, the second voltage signal line 52, the third voltage signal line 53 and the fourth voltage signal line 54, respectively.

Referring continuously to FIGS. 4 and 21, in some embodiments, a gating unit 30 is configured to output a gate driving signal based on at least the stage transfer signal NEXT, the frequency control signal CTRL and the sixth voltage signal VGLB. The sixth voltage signal VGLB and the second voltage signal VGLA are signals of the same level type, and/or the sixth voltage signal VGLB and the fourth voltage signal VGLA′ are signals of the same level type. The voltage signal lines 60 of the display panel also include a fifth voltage signal line 55 and a sixth voltage signal line 56. The fifth voltage signal line 55 is used to transmit at least one of the second voltage signal VGLA and the fourth voltage signal VGLA′, and the sixth voltage signal line 56 is used to transmit the sixth voltage signal VGLB.

In the disclosed embodiment, the sixth voltage signal VGLB and the fourth voltage signal VGLA′ have the same level type, and/or the sixth voltage signal VGLB and the second voltage signal VGLA have the same level type. Optionally, the sixth voltage signal VGLB, the fourth voltage signal VGLA′ and the second voltage signal VGLA are all low-level signals, and the first voltage signal VGHA, the third voltage signal VGHD, the fifth voltage signal VGHB and the seventh voltage signal VGHC are all high-level signals. In the disclosed embodiment, a fifth voltage signal line 55 is introduced in the display panel to transmit the second voltage signal VGLA or the fourth voltage signal VGLA′, and a sixth voltage signal line 56 is introduced to transmit the sixth voltage signal VGLB. In some embodiments, the low-level signal corresponding to the first control unit 10 and the first output unit 20 is transmitted by the fifth voltage signal line 55, and the low-level signal corresponding to the second control unit 31 and the second output unit 32 is transmitted by the sixth voltage signal line 56 as an example for explanation. The manner of setting the fifth voltage signal line 55 and the sixth voltage signal line 56 separately helps avoid the low-level signal in the gating unit 30 being affected by the low-level signals of the first control unit 10 and the first output unit 20, thereby helping to improve the accuracy of the gate driving signal output by the gating unit.

Referring continuously to FIGS. 1 and 21, in some embodiments, the display panel includes a display area AA and a first non-display area A1 located on one side of the display area AA along a first direction D1. The first non-display area A1 includes a fan-out area Q1 and a bending area Q2. The fan-out area Q1 is located between the bending area Q2 and the display area. The fan-out area Q1 includes a fifth fan-out line 95, the bending area Q2 includes a fourth lead 84, the fifth voltage signal line 55 and the sixth voltage signal line 56 are connected to the same fifth fan-out line 95, and the fifth fan-out line 95 is electrically connected to the fourth lead 84.

Optionally, the level type of the second voltage signal VGLA, the fourth voltage signal VGLA′ and the sixth voltage signal VGLB are the same, and the three have the same voltage value. In order to realize the electrical connection between the fifth voltage signal line 55 and the sixth voltage signal line 56 and the binding pad P3 in the pad area Q4, in the disclosed embodiment, a fifth fan-out line 95 is introduced in the fan-out area Q1, and a fourth lead 84 is introduced in the bending area Q2. The fifth voltage signal line 55 and the sixth voltage signal line 56 are electrically connected to the fourth lead 84 through the same fifth fan-out line 95, and then the electrical connection with the same third binding pad P3 may be realized through the fourth lead 84. In this way, the number of fan-out lines and the number of leads corresponding to the fifth voltage signal line 55 and the sixth voltage signal line 56 may be reduced, which is conducive to simplifying the wiring difficulty of the display panel while realizing the effective transmission of the voltage signal.

Referring continuously to FIG. 13, in some embodiments, the fifth voltage signal line 55 and the sixth voltage signal line 56 are electrically connected via a second connection portion 72. The second connection portion 72 is located on a side of the fan-out area Q1 away from the bending area Q2.

During actual wiring, the fifth voltage signal line 55 and the sixth voltage signal line 56 connect different units in a shift register 01. For example, the fifth voltage signal line 55 is used to electrically connect to the first control unit 10 and the first output unit 20 in the shift register 01, while the sixth voltage signal line 56 is electrically connected to the second control unit 31 and the second output unit 32 in the gating unit 30 of the shift register 01. In order to achieve the nearby connection between the fifth voltage signal line 55 and the first control unit 10 and the first output unit 20, the fifth voltage signal line 55 may be set between the first control unit 10 and the first output unit 20. In order to achieve the nearby connection between the sixth voltage signal line 56 and the gating unit 30, the sixth voltage signal line 56 may be set on the side of the gating unit 30 away from the first output unit 20, or set between the second control unit 31 and the second output unit 32. In this way, the fifth voltage signal line 55 and the sixth voltage signal line 56 are not adjacent, and at least the first output unit 20 is spaced between the two lines. To realize the electrical connection between the fifth voltage signal line 55 and the sixth voltage signal line 56 and the same fifth fan-out line 95, the ends of the fifth voltage signal line 55 and the sixth voltage signal line 56 close to the fan-out area Q1 may be electrically connected through the second connection portion 72, and then electrically connected to the fifth fan-out line 95 through the second connection portion 72. At this moment, the second connection portion 72 may be located on the side of the fan-out area Q1 away from the bending area Q2, and does not occupy the space of the fan-out area Q1, so as not to affect the original wiring in the fan-out area Q1, and also will not increase the number of fan-out lines in the fan-out area Q1.

Optionally, if there is sufficient space in the display panel, different fan-out lines and leads may be introduced for the fifth voltage signal line 55 and the sixth voltage signal line 56 respectively. The two leads are electrically connected in the wiring area Q4 and then connected to the binding pad P3 to improve the stability of the signals transmitted to the fifth voltage signal line 55 and the sixth voltage signal line 56.

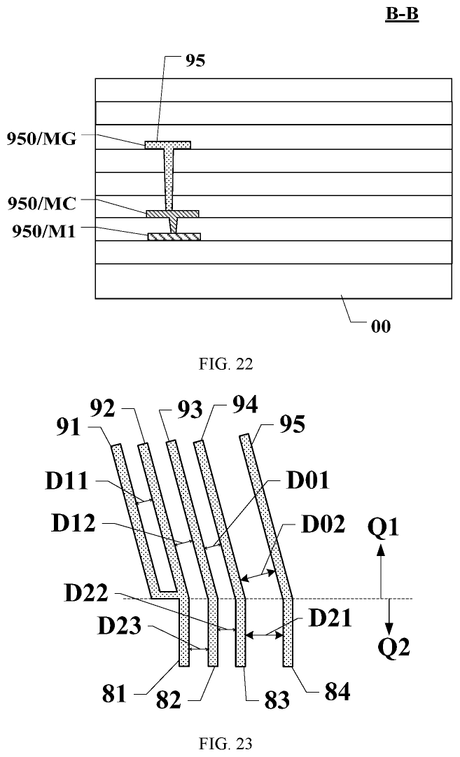

FIG. 22 is a CC cross-sectional view of FIG. 21. Referring to FIG. 22, in some embodiments, the fifth fan-out line 95 includes at least two sub-fan-out lines 950 located in different metal layers and electrically connected. The embodiment of FIG. 22 is described by taking the fifth fan-out line 95 including sub-fan-out lines 950 located in three metal layers as an example, but the present disclosure does not limit the number of sub-fan-out lines 950 included in the fifth fan-out line 95. In some embodiments, the fifth fan-out line 95 may also include two sub-fan-out lines or more than three sub-fan-out lines. When the fifth fan-out line 95 includes at least two sub-fan-out lines 950 located in different metal layers, at least two sub-fan-out lines 950 are in a parallel structure, which may reduce the overall impedance of the fifth fan-out line 95, which helps increase the efficiency of the voltage signal transmitted on the fifth sub-fan-out line.

It should be noted that the embodiment shown in FIG. 22 is illustrated by taking the three sub-fan-out lines 950 in the fifth fan-out line as an example in which the three sub-fan-out lines 950 are respectively located in the gate metal layer MG, the capacitor metal layer MC and the first metal layer M1, but the present disclosure is not limited thereto. In some embodiments, the sub-fan-out lines 950 in the fifth fan-out line 95 may also be disposed in other feasible metal film layers.

Referring continuously to FIGS. 1, 4 and 13, in some embodiments, the voltage signal lines 60 in the display panel include a first type of voltage signal line 61 and a second type of voltage signal line 62, where the first type of voltage signal line 61 is electrically connected to at least the stage transfer units 03, and the second type of voltage signal line 62 is electrically connected to the gating units 30. In the disclosed embodiment, the first type of voltage signal line 61 includes the first voltage signal line 51, the second voltage signal line 52, and the fifth voltage signal line 55. The second type of voltage signal line 62 includes the third voltage signal line 53, the fourth voltage signal line 54 and the sixth voltage signal line 56.

The display panel includes a display area AA and a first non-display area A1 located on one side of the display area AA along a first direction D1, and the first non-display area A1 includes a fan-out area Q1. The fan-out area Q1 includes a first type of fan-out line S01 and a second type of fan-out line S02, the first type of fan-out line S01 is electrically connected to the first type of voltage signal line 61, and the second type of fan-out line S02 is electrically connected to the second type of voltage signal line 62. In the disclosed embodiment, the first type of fan-out line S01 includes a first fan-out line 91 and a second fan-out line 92, and the second type of fan-out line S02 includes a third fan-out line 93, a fourth fan-out line 94 and a fifth fan-out line 95.

The number of film layers occupied by at least one first type fan-out line S01 in the display panel is n1, and the number of film layers occupied by at least one second type fan-out line S02 in the display panel is n2, where n1≤n2. The film layers occupied by the fan-out line in the display panel refer to the wiring film layers of the fan-out line in the display panel. For example, a fan-out line may be wired on the metal film layers shown in the embodiment shown in FIG. 15, and illustratively, may be distributed in at least one metal film layer among the first metal layer M1, the capacitor metal layer MC, and the gate metal layer MG.

Considering that the second type voltage signal line 62 corresponding to the second type fan-out line S02 is connected to a gating unit 30, the gating unit 30 is a unit that finally outputs the gate driving signal in the display panel, and outputs the gate driving signal at least according to the voltage signal transmitted on the second type voltage signal line 62. Therefore, the stability of the voltage signal transmitted on the second type voltage signal line 62 directly determines the stability of the gate driving signal finally output. In the disclosed embodiment, when the number of film layers occupied by the second type fan-out line S02 corresponding to the second type voltage signal line 62 in the display panel is set to be large, the multi-layer parallel routing method reduces the impedance of the second type fan-out line S02. This is conducive to reducing the overall impedance of the second type voltage signal line 62 and the second type fan-out line S02, so that the voltage signal transmitted on the second type fan-out line S02 and the second type voltage signal line 62 is more stable, so it is conducive to improving the stability of the gate driving signal output by the gating unit 30. Since the first voltage signal line 61 is electrically connected to the stage transfer units, the signal thereon will not directly affect the stability of the gate driving signal. Therefore, the first fan-out line S01 corresponding to the first voltage signal line 61 may occupy fewer film layers to save wiring space.

In the disclosed embodiment, the number of film layers occupied by at least one second fan-out line S02 corresponding to the second type voltage signal line 62 connected to the second output unit 32 of the gating unit 30 is n2, and the number of film layers occupied by at least one first fan-out line S01 corresponding to the first type voltage signal line 61 connected to the stage transfer unit 03 is n1, and n1≤n2.

Referring to FIG. 4 and FIG. 13, in some embodiments, a gating unit 30 includes a second control unit 31 and a second output unit 32. The second control unit 31 is configured to control the signal of the fifth node N5 at least according to the first voltage signal VGHA, the signal of the first node N1, the stage transfer signal NEXT and the frequency control signal CTRL. The second output unit 32 is configured to output the gate driving signal at least according to the signal of the fifth node N5, the second node N2 and the fifth voltage signal VGHB or the seventh voltage signal VGHC. The fifth voltage signal VGHB, the seventh voltage signal VGHC and the first voltage signal VGHA are signals of the same level type. The first type voltage signal line 61 includes a first voltage signal line 51 and a second voltage signal line 52, and the second type voltage signal line 62 includes a third voltage signal line 53 and a fourth voltage signal line 54. The third voltage signal line 53 is used to transmit the fifth voltage signal VGHB, and the fourth voltage signal line 54 is used to transmit the seventh voltage signal VGHC. The first type of fan-out line S01 includes a first fan-out line 91 and a second fan-out line 92, and the second type of fan-out line S02 includes a third fan-out line 93 and a fourth fan-out line 94. The first fan-out line 91 is electrically connected to the first voltage signal line 51, the second fan-out line 92 is electrically connected to the second voltage signal line 52, the third fan-out line 93 is electrically connected to the third voltage signal line 53, and the fourth fan-out line 94 is electrically connected to the fourth voltage signal line 54.

Referring to FIGS. 16, 19 and 20, the number of film layers occupied by the first fan-out line 91 in the display panel is n11, the number of film layers occupied by the second fan-out line 92 in the display panel is n12, the number of film layers occupied by the third fan-out line 93 in the display panel is n21, and the number of film layers occupied by the fourth fan-out line 94 in the display panel is n22, where n11<n21, n 11<n22, and/or, n 12<n21, n 12<n22. The embodiment shown in FIG. 16 is described by taking n11=2, n12=1 as an example, FIG. 19 is described by taking n21=n22=2 as an example, and FIG. 20 is described by taking n21=n22=3 as an example.

In the present disclosure, the first voltage signal line 51 and the second voltage signal line 52 transmit voltage signals to the units inside the shift registers, and do not transmit signals to the pixel driving circuits, while the third voltage signal line 53 and the fourth voltage signal line 54 are voltage signal lines connected to the second output units 32 in the shift registers. When the third output module 311 in a second output unit 32 is turned on, the voltage signal in the third voltage signal line 53 or the fourth voltage signal line 54 will be output as a gate driving signal from the output terminal SN_OUT of a gating unit, so the stability of the voltage signals on the third voltage signal line 53 and the fourth voltage signal line 54 directly determines the stability of the gate driving signal transmitted by the pixel driving circuits. Therefore, in the disclosed embodiment, when the number of film layers occupied by the third fan-out line 93 and the fourth fan-out line 94 corresponding to the third voltage signal line 53 and/or the fourth voltage signal line 54 is set to be greater than the number of film layers occupied by the first fan-out line 91 and the second fan-out line 92, it helps reduce the impedance of the third fan-out line 93 and/or the fourth fan-out line 94. This thus helps reduce the total impedance of the third fan-out line 93 and the third voltage signal line 53, and/or reduce the total impedance of the fourth fan-out line 94 and the fourth voltage signal line 54, so it helps improve the stability of the voltage signals transmitted by the third voltage signal line 53 and the fourth voltage signal line 54, and it helps improve the stability of the gate driving signal output by a shift register.

It should be noted that, in the fan-out area, among the fan-out lines extending in the same or approximately the same direction, the intervals between adjacent fan-out lines may be set to be the same, so as to simplify the wiring difficulty of the fan-out lines in the fan-out area.

In some embodiments, the intervals between at least some of the different fan-out lines may also be designed differently. For example, FIG. 23 shows a schematic layout diagram of some signal lines in the fan-out area and the bending area. Referring to FIG. 23, optionally, the third fan-out line 93 and the fifth fan-out line 05 are respectively located on two opposite sides of the fourth fan-out line 94 and are respectively adjacent to the fourth fan-out line 94. The spacing width D01 between the third fan-out line 93 and the fourth fan-out line 94 is less than the spacing width D02 between the fourth fan-out line 94 and the fifth fan-out line 95. In some embodiments, the level types of the voltage signals transmitted by the third fan-out line 93 and the fourth fan-out line 94 are the same, for example, both are high-level signals, and the level type of the voltage signal transmitted by the fifth fan-out line 95 is different from that of the fourth fan-out line 94. For example, the voltage signal transmitted by the fifth fan-out line 95 is a low-level signal or an AC signal, and the voltage signal transmitted by the fourth fan-out line 94 is a high-level signal. Therefore, in the present disclosure, when the third fan-out line 93 and the fourth fan-out line 94 are disposed at a relatively close distance, the signals therebetween will not affect each other. When the fifth fan-out line 95 is disposed at a relatively far distance from the fourth fan-out line 94, it is advantageous to avoid the mutual coupling influence of the signals therebetween. A similar design is adopted for the spacing relationship between the second lead 82, the third lead 83, and the fourth lead 84, and the spacing width D22 between the second lead 82 and the third lead 83 is smaller than the spacing width D21 between the fourth lead 84 and the third lead 83, which is also advantageous to reduce the mutual coupling influence between different types of signals.

In the fan-out area Q1, the spacing widths between at least some of the fan-out lines that transmit the same signal are the same. For example, the voltage signals transmitted by the first fan-out line 91, the second fan-out line 92, the third fan-out line 93, and the fourth fan-out line 94 have the same level type and the same voltage value, for example, they are all high-level signals. At this moment, the spacing width D11 between the first fan-out line 91 and the second fan-out line 92 may be set equal to the spacing width D01 between the third fan-out line 93 and the fourth fan-out line 94. Optionally, if the second fan-out line 92 is located between the first fan-out line 91 and the third fan-out line 93, and no other fan-out line is set between the second fan-out line 92 and the third fan-out line 93, assuming that the spacing width between the second fan-out line 92 and the third fan-out line 93 is D12, D12=D11=D01 may be further set. In this way, the fan-out lines that transmit the same signal may be disposed using the same spacing standard, which is conducive to simplifying the wiring difficulty of the fan-out area.

In the bending area Q2, the spacing widths between at least some of the leads transmitting the same signal are the same. For example, the voltage signals transmitted by the first lead 81, the second lead 82 and the third lead 83 have the same level type and the same voltage value, for example, all are high level. Accordingly, the spacing width D23 between the first lead 81 and the second lead 82 may be set equal to the spacing width D22 between the second lead 82 and the third lead 83, which is also helpful in simplifying the wiring difficulty of the bending area.

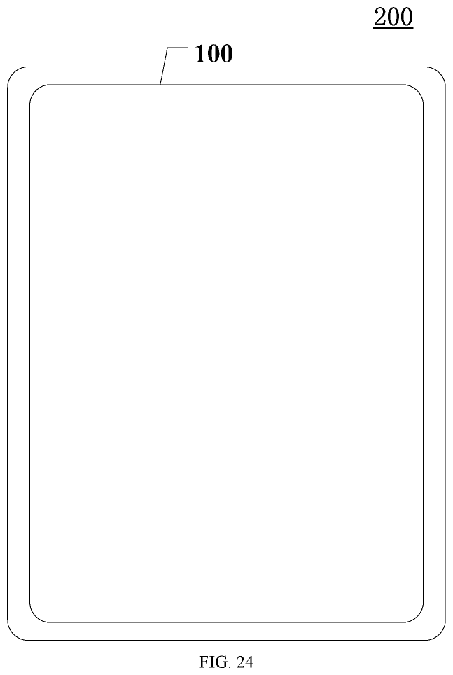

Based on similar inventive concepts, the present disclosure also provides a display device. FIG. 24 is a schematic diagram of a structure of a display device 200 in accordance with an embodiment of the present disclosure. Referring to FIG. 24, the display device 200 includes a display panel 100 in any of the above embodiments. The display device 200 in accordance with an embodiment of the present disclosure may be any electronic device with a display function, such as a touch screen, a mobile phone, a tablet computer, a laptop computer, an e-book, a television, etc. The display device 200 has the beneficial effects of the display panel provided by the embodiments of the disclosure. For details, refer to the specific description of the display panel in the above embodiments, which will not be repeated here.

It may be understood that FIG. 24 merely illustrates one shape of the display device 200 by taking a rounded rectangular structure as an example. In some embodiments, the display device 200 may also be circular, elliptical or any other feasible shape, which is not specifically limited in the present disclosure.

In summary, the technical solutions provided by the embodiments of the present disclosure have the following advantages.

In the display panel and display device provided by the embodiments of the present disclosure, the first voltage signal corresponding to the first control unit in a shift register is transmitted by a first voltage signal line, and the third voltage signal corresponding to the first output unit is transmitted by a second voltage signal line. The first voltage signal and the third voltage signal have the same level type. That is, both are high-level signals or both are low-level signals, but the two are transmitted by different voltage signal lines. When the coupling of the clock signal affects the first voltage signal, since the third voltage signal is transmitted by the second signal line, the third voltage signal will not be affected by the coupling of the clock signal. When the stage transfer signal output by the first output unit is the third voltage signal, the third voltage signal is a stable voltage signal transmitted by the second signal line, which may realize accurate control of the gating unit. Therefore, the embodiments of the present disclosure introduce different voltage signal lines for the first control unit and the first output unit to transmit the first voltage signal and the third voltage signal of the same level type, which helps improve the transmission accuracy of the stage transfer signal, and further improve the accuracy of the gate driving signal output by the gate drive circuit.

It should be noted that, in this disclosure, relational terms such as “first” and “second” are merely used to distinguish one entity or operation from another entity or operation, and do not necessarily require or imply any such actual relationship or order between these entities or operations. Moreover, the terms “include”, “include” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “include a . . . ” do not exclude the existence of other identical elements in the process, method, article or device including the elements.

The foregoing description includes merely specific embodiments of the present disclosure, so that those skilled in the art may understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments described herein, but will conform to the widest scope consistent with the principles and novel features disclosed herein.

What is claimed is:

1. A display panel, comprising a gate driving circuit, the gate driving circuit including N stages of shift registers cascaded to each other, N≥2 and N being an integer, a shift register including a stage transfer unit and a gating unit connected to the stage transfer unit, and the stage transfer unit including a first control unit and a first output unit, wherein:
the first control unit is configured to control a signal of a first node and a signal of a second node according to at least a first voltage signal, a second voltage signal, a first clock signal, and a second clock signal;
the first output unit is configured to output a stage transfer signal according to at least the signal of the first node, the signal of the second node, a third voltage signal and a fourth voltage signal, wherein a stage transfer signal of an i-th stage shift register is used as an input signal of a j-th stage shift register, wherein 1≤i≤N, 1≤j≤N, i≠j, i and j are both integers;
the gating unit is configured to output a gate driving signal according to at least the stage transfer signal and a frequency control signal; and
the display panel includes voltage signal lines, and the voltage signal lines include a first voltage signal line and a second voltage signal line, the first voltage signal line is used to transmit the first voltage signal, and the second voltage signal line is used to transmit the third voltage signal, and the first voltage signal and the third voltage signal have a same level type.

2. The display panel according to claim 1, wherein, in the N stages of the shift registers cascaded to each other, first control units in different shift registers are connected to a same first voltage signal line.

3. The display panel according to claim 1, wherein in the N stages of shift registers cascaded to each other, first output units in different shift registers are connected to a same second voltage signal line.

4. The display panel according to claim 1, wherein the first voltage signal and the third voltage signal have a same voltage value.

5. The display panel according to claim 1, wherein the second voltage signal and the fourth voltage signal are signals with a same voltage value and are provided by a same voltage signal line.

6. The display panel according to claim 1, wherein:
the display panel includes a display area and a first non-display area located at one side of the display area along a first direction, the first non-display area includes a fan-out area and a bending area, and the fan-out area is located between the bending area and the display area; and
the fan-out area includes a first fan-out line and a second fan-out line, the first fan-out line is electrically connected to the first voltage signal line, and the second fan-out line is electrically connected to the second voltage signal line, and the bending area includes a first lead, and the first fan-out line and the second fan-out line are electrically connected to a same first lead.

7. The display panel according to claim 6, wherein ends of the first fan-out line and the second fan-out line away from the display area are electrically connected via a first connecting portion, and the first connecting portion is located in the fan-out area.

8. The display panel according to claim 6, wherein the first fan-out line and the second fan-out line are located in different film layers.

9. The display panel according to claim 8, wherein the first fan-out line includes a first sub-line and a second sub-line which are electrically connected, and the first sub-line and the second sub-line are disposed in different film layers.

10. The display panel according to claim 6, wherein the first non-display area includes a pad area, the pad area is located on a side of the bending area away from the display area, the pad area includes a plurality of binding pads, the binding pads include a first binding pad, and the first lead is electrically connected to the first binding pad.

11. The display panel according to claim 1, wherein the gating unit includes a second control unit and a second output unit, the second control unit is configured to control a signal of a fifth node at least according to the first voltage signal, the signal of the first node, the stage transfer signal and the frequency control signal, and the second output unit is configured to output the gate driving signal at least according to the signal of the fifth node and the signal of the second node.

12. The display panel according to claim 11, wherein the N stages of shift registers cascaded to each other include a first shift register and a second shift register, a second output unit of the first shift register is configured to output the gate driving signal according to a fifth voltage signal, a sixth voltage signal and a signal of a seventh node, and a second output unit of the second shift register is configured to output the gate driving signal according to a seventh voltage signal, the sixth voltage signal and a signal of the seventh node, the fifth voltage signal, the seventh voltage signal and the third voltage signal are signals of a same level type, and the sixth voltage signal, the fourth voltage signal and the second voltage signal are signals of a same level type.

13. The display panel according to claim 12, wherein the fifth voltage signal, the seventh voltage signal, the third voltage signal and the first voltage signal have a same voltage value, and/or the sixth voltage signal, the fourth voltage signal and the second voltage signal have a same voltage value.

14. The display panel according to claim 12, wherein the fifth voltage signal, the seventh voltage signal, the third voltage signal and the first voltage signal are high-level signals.

15. The display panel according to claim 12, wherein the sixth voltage signal, the fourth voltage signal and the second voltage signal are low-level signals.

16. The display panel according to claim 12, wherein:
the first shift register is located at an odd-numbered stage, and the second shift register is located at an even-numbered stage; or
the first shift register is located at an even-numbered stage, and the second shift register is located at an odd-numbered stage.

17. The display panel according to claim 12, wherein:
the voltage signal lines further include a third voltage signal line and a fourth voltage signal line, the third voltage signal line is used to transmit the fifth voltage signal, and the fourth voltage signal line is used to transmit the seventh voltage signal;
the display panel includes a display area and a first non-display area located at one side of the display area along a first direction, the first non-display area includes a fan-out area and a bending area, and the fan-out area is located between the bending area and the display area; and
the fan-out area includes a third fan-out line and a fourth fan-out line, the third fan-out line is electrically connected to the third voltage signal line, and the fourth fan-out line is electrically connected to the fourth voltage signal line, the bending area includes a second lead and a third lead, the second lead is electrically connected to the third fan-out line, and the third lead is electrically connected to the fourth fan-out line.

18. The display panel according to claim 1, wherein:
the voltage signal line includes a first type of voltage signal line and a second type of voltage signal line, the first type of voltage signal line is at least electrically connected to the stage transfer unit, and the second type of voltage signal line is electrically connected to the gating unit;
the display panel includes a display area and a first non-display area located at one side of the display area along a first direction, the first non-display area includes a fan-out area, the fan-out area includes a first type of fan-out line and a second type of fan-out line, the first type of fan-out line is electrically connected to the first type of voltage signal line, and the second type of fan-out line is electrically connected to the second type of voltage signal line; and
a quantity of film layers occupied by at least one first type fan-out line in the display panel is n1, and a quantity of film layers occupied by at least one second type fan-out line in the display panel is n2, wherein n1≤n2.

19. The display panel according to claim 18, wherein:
the gating unit includes a second control unit and a second output unit, the second control unit is configured to control the signal of a fifth node at least according to the first voltage signal, the signal of the first node, the stage transfer signal and the frequency control signal, and the second output unit is configured to output the gate driving signal at least according to the signal of the fifth node, the signal of the second node and a fifth voltage signal or a seventh voltage signal, the fifth voltage signal, the seventh voltage signal and the first voltage signal are signals of a same level type;
the first type of voltage signal line includes the first voltage signal line and the second voltage signal line, the second type of voltage signal line includes a third voltage signal line and a fourth voltage signal line, the third voltage signal line is used to transmit the fifth voltage signal, and the fourth voltage signal line is used to transmit the seventh voltage signal;
the first type of fan-out line includes a first fan-out line and a second fan-out line, the second type of fan-out line includes a third fan-out line and a fourth fan-out line, the first fan-out line is electrically connected to the first voltage signal line, the second fan-out line is electrically connected to the second voltage signal line, the third fan-out line is electrically connected to the third voltage signal line, and the fourth fan-out line is electrically connected to the fourth voltage signal line; and
a quantity of film layers occupied by the first fan-out line in the display panel is n11, a quantity of film layers occupied by the second fan-out line in the display panel is n12, a quantity of film layers occupied by the third fan-out line in the display panel is n21, and a quantity of film layers occupied by the fourth fan-out line in the display panel is n22, wherein n11<n21, n11<n22, and/or, n12<n21, n12<n22.

20. A display device, comprising a display panel, and the display panel including a gate driving circuit, the gate driving circuit including N stages of shift registers cascaded to each other, N≥2 and N being an integer, a shift register including a stage transfer unit and a gating unit connected to the stage transfer unit, and the stage transfer unit including a first control unit and a first output unit, wherein:
the first control unit is configured to control a signal of a first node and a signal of a second node according to at least a first voltage signal, a second voltage signal, a first clock signal, and a second clock signal;
the first output unit is configured to output a stage transfer signal according to at least the signal of the first node, the signal of the second node, a third voltage signal and a fourth voltage signal, wherein a stage transfer signal of an i-th stage shift register is used as an input signal of a j-th stage shift register, wherein 1≤i≤N, 1≤j≤N, i≠j, i and j are both integers;
the gating unit is configured to output a gate driving signal according to at least the stage transfer signal and a frequency control signal; and
the display panel includes voltage signal lines, and the voltage signal lines include a first voltage signal line and a second voltage signal line, the first voltage signal line is used to transmit the first voltage signal, and the second voltage signal line is used to transmit the third voltage signal, and the first voltage signal and the third voltage signal have a same level type.
